(19) United States
(12) Patent Application Publication
(10) Pub. No.: US 2024/0306168 A1
(43) Pub. Date: Sep. 12, 2024

(54) USER EQUIPMENT ASSISTED BIDIRECTIONAL FULL DUPLEX SIDELINK TRANSMISSIONS

(71) Applicant: QUALCOMM Incorporated, San Diego, CA (US)

(72) Inventors: Yan ZHOU, San Diego, CA (US); Hemant SAGGAR, San Diego, CA (US)

(21) Appl. No.: 18/179,000

(22) Filed: Mar. 6, 2023

(51) Int. Cl. H04W 72/40; H04L 5/14; H04W 72/12; H04W 72/232

(52) U.S. Cl. CPC H04W 72/40; H04L 5/14; H04W 72/12; H04W 72/232

(57) ABSTRACT

Various aspects of the present disclosure generally relate to wireless communication. In some aspects, a first user equipment (UE) may transmit, to a network node, an indication that a bidirectional full duplex sidelink transmission between the first UE and a second UE is feasible. The first UE may transmit, to the network node, sidelink scheduling information that is recommended for the bidirectional full duplex sidelink transmission. The first UE may receive, from the network node, downlink control information (DCI) that schedules the bidirectional full duplex sidelink transmission, the DCI being based at least in part on the sidelink scheduling information and the indication that the bidirectional full duplex sidelink transmission between the first UE and the second UE is feasible. The first UE may transmit, to the second UE, the bidirectional full duplex sidelink transmission. Numerous other aspects are described.

### FIELD OF THE DISCLOSURE

Aspects of the present disclosure generally relate to wireless communication and to techniques and apparatuses for user equipment (UE)-assisted bidirectional full duplex sidelink transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes a memory and one or more processors, coupled to the memory, configured to: transmit, to a network node, an indication that a bidirectional full duplex sidelink transmission between the first UE and a second UE is feasible; transmit, to the network node, sidelink scheduling information that is recommended for the bidirectional full duplex sidelink transmission; receive, from the network node, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible; and transmit, to the second UE, the bidirectional full duplex sidelink transmission based at least in part on the DCI.

In some implementations, an apparatus for wireless communication at a network node includes a memory and one or more processors, coupled to the memory, configured to: receive, from a first UE, an indication that a bidirectional full duplex sidelink transmission between the first UE and a second UE is feasible; receive, from the first UE, sidelink scheduling information that is recommended for the bidirectional full duplex sidelink transmission; and transmit, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible.

In some implementations, a method of wireless communication performed by a first UE includes transmitting, to a network node, an indication that a bidirectional full duplex sidelink transmission between the first UE and a second UE is feasible; transmitting, to the network node, sidelink scheduling information that is recommended for the bidirectional full duplex sidelink transmission; receiving, from the network node, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible; and transmitting, to the second UE, the bidirectional full duplex sidelink transmission based at least in part on the DCI.

In some implementations, a method of wireless communication performed by a network node includes receiving, from a first UE, an indication that a bidirectional full duplex sidelink transmission between the first UE and a second UE is feasible; receiving, from the first UE, sidelink scheduling information that is recommended for the bidirectional full duplex sidelink transmission; and transmitting, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible.

In some implementations, a non-transitory computer-readable medium storing a set of instructions for wireless communication includes one or more instructions that, when executed by one or more processors of a first UE, cause the first UE to: transmit, to a network node, an indication that a bidirectional full duplex sidelink transmission between the first UE and a second UE is feasible; transmit, to the network node, sidelink scheduling information that is recommended for the bidirectional full duplex sidelink transmission; receive, from the network node, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible; and transmit, to the second UE, the bidirectional full duplex sidelink transmission based at least in part on the DCI.

In some implementations, a non-transitory computer-readable medium storing a set of instructions for wireless communication includes one or more instructions that, when executed by one or more processors of a network node, cause the network node to: receive, from a first UE, an indication that a bidirectional full duplex sidelink transmission between the first UE and a second UE is feasible; receive, from the first UE, sidelink scheduling information that is recommended for the bidirectional full duplex sidelink transmission; and transmit, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible.

In some implementations, a first apparatus for wireless communication includes means for transmitting, to a network node, an indication that a bidirectional full duplex sidelink transmission between the first apparatus and a second apparatus is feasible; means for transmitting, to the network node, sidelink scheduling information that is recommended for the bidirectional full duplex sidelink transmission; means for receiving, from the network node, DCI that schedules the bidirectional full duplex sidelink transmission via a sidelink grant, the DCI being based at least in part on the indication that the bidirectional full duplex sidelink transmission between the first apparatus and the second apparatus is feasible and the sidelink scheduling information;

and means for transmitting, to the second apparatus, the bidirectional full duplex sidelink transmission based at least in part on the DCI.

In some implementations, an apparatus for wireless communication includes means for receiving, from a first UE, an indication that a bidirectional full duplex sidelink transmission between the first UE and a second UE is feasible; means for receiving, from the first UE, sidelink scheduling information that is recommended for the bidirectional full duplex sidelink transmission; and means for transmitting, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of full duplex in a vehicle-to-everything (V2X) system, in accordance with the present disclosure.

FIG. 5 is a diagram illustrating an example of sidelink bidirectional full duplex communications, in accordance with the present disclosure.

FIG. 6 is a diagram illustrating an example of self-interference associated with a UE, in accordance with the present disclosure.

FIGS. 7-14 are diagrams illustrating examples associated with UE-assisted bidirectional full duplex sidelink transmissions, in accordance with the present disclosure.

FIGS. 15-16 are diagrams illustrating example processes associated with UE-assisted bidirectional full duplex sidelink transmissions, in accordance with the present disclosure.

FIGS. 17-18 are diagrams of example apparatuses for wireless communication, in accordance with the present disclosure.

### DETAILED DESCRIPTION

A network node may need to determine whether a bidirectional sidelink full duplex is feasible for two sidelink full duplex user equipments (UEs), in order to schedule bidirectional full duplex sidelink transmissions between the two sidelink UEs.

The network node may determine a sidelink full duplex feasibility, for example, via collecting full duplex performance related metrics from each sidelink UE, but such an approach may have a non-negligible impact on overhead and latency. In other words, determining the sidelink full duplex feasibility by collecting the full duplex performance related metrics from each sidelink UE may increase a signaling overhead, thereby degrading an overall network performance.

In some aspects described herein, a first UE may transmit, to a network node, an indication that a bidirectional full duplex sidelink transmission between the first UE and a second UE is feasible. The first UE may be able to determine that the bidirectional full duplex sidelink transmission is feasible based at least in part on a self-interference measurement. The first UE may transmit, to the network node, sidelink scheduling information that is recommended for the bidirectional full duplex sidelink transmission. The first UE may receive, from the network node, DCI that schedules the bidirectional full duplex sidelink transmission via a sidelink grant. The DCI may be based at least in part on the sidelink scheduling information and the indication that the bidirectional full duplex sidelink transmission between the first UE and the second UE is feasible. The first UE may transmit, to the second UE, the bidirectional full duplex sidelink transmission based at least in part on the DCI.

In some aspects, rather than the network node determining a sidelink full duplex feasibility by collecting full duplex performance related metrics from each sidelink UE, which would otherwise increase a signaling overhead and a latency, sidelink UEs may instead inform the network node of the sidelink full duplex feasibility.

The network node may use such information before scheduling bidirectional full duplex sidelink transmissions between the two sidelink UEs. Such an approach may improve the signaling overhead and the latency, thereby improving an overall performance of the first UE and/or the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

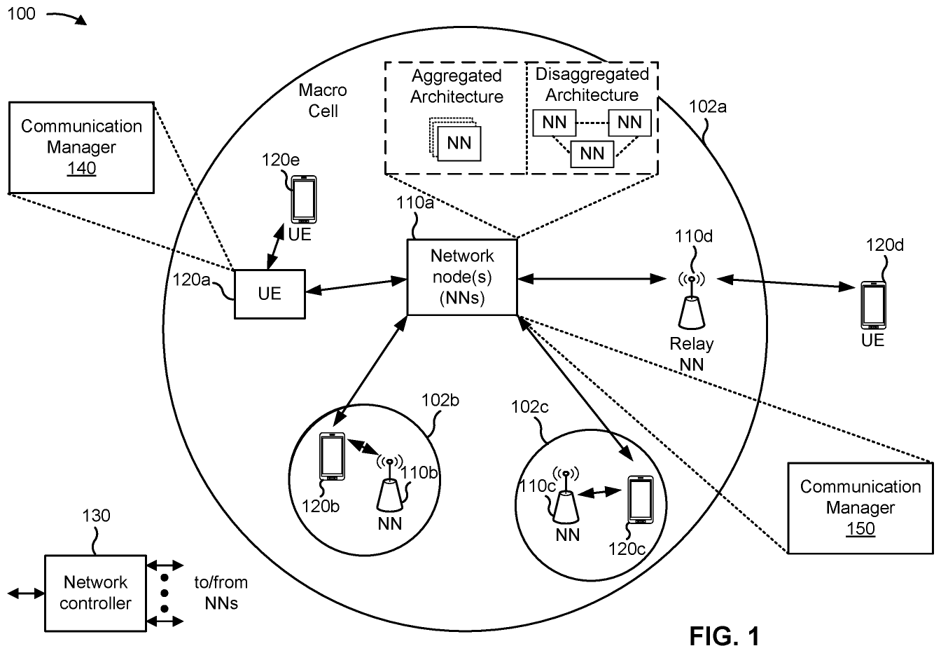

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71

GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120) may include a communication manager 140. As described in more detail elsewhere herein, the communication manager 140 may transmit, to a network node, an indication that a bidirectional full duplex sidelink transmission between the first UE and a second UE is feasible; transmit, to the network node, sidelink scheduling information that is recommended for the bidirectional full duplex sidelink transmission; receive, from the network node, DCI that schedules the bidirectional full duplex sidelink transmission via a sidelink grant, the

DCI being based at least in part on the sidelink scheduling information and the indication that the bidirectional full duplex sidelink transmission between the first UE and the second UE is feasible; and transmit, to the second UE, the bidirectional full duplex sidelink transmission based at least in part on the DCI. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, from a first UE, an indication that a bidirectional full duplex sidelink transmission between the first UE and a second UE is feasible; receive, from the first UE, sidelink scheduling information that is recommended for the bidirectional full duplex sidelink transmission; and transmit, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible. Additionally, or alternatively, the communication manager 150 may perform one or more other operations described herein.

As indicated above, FIG. 1 is provided as an example. Other examples may differ from what is described with regard to FIG. 1.

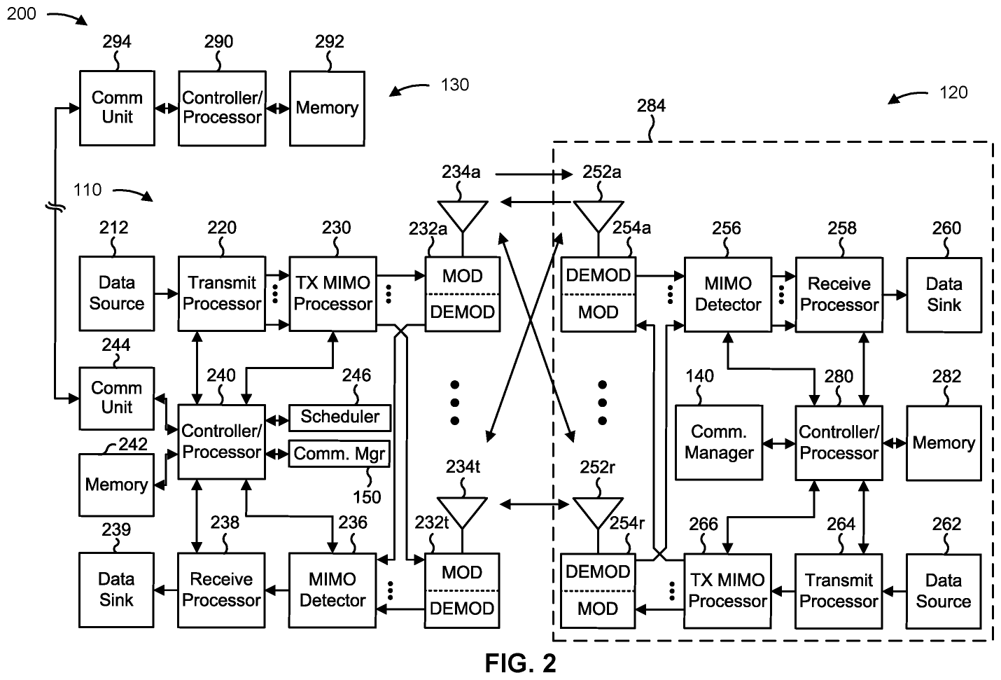

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

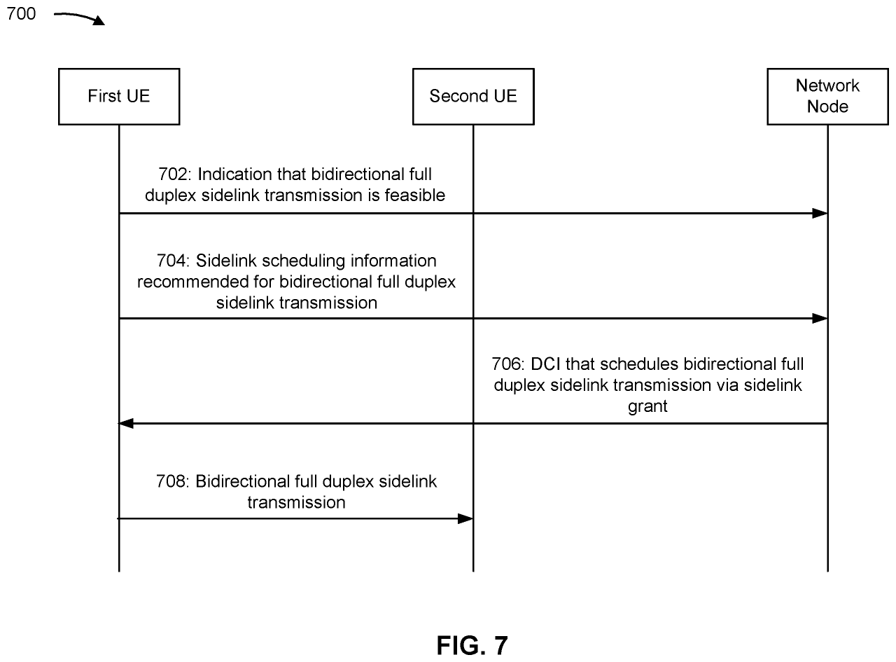

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the Tx MIMO processor 266. The transceiver may be used by a processor (e.g., the controller/processor 280) and the memory 282 to perform aspects of any of the methods described herein (e.g., with reference to FIGS. 7-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244.

The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the Tx MIMO processor 230. The transceiver may be used by a processor (e.g., the controller/processor 240) and the memory 242 to perform aspects of any of the methods described herein (e.g., with reference to FIGS. 7-18).

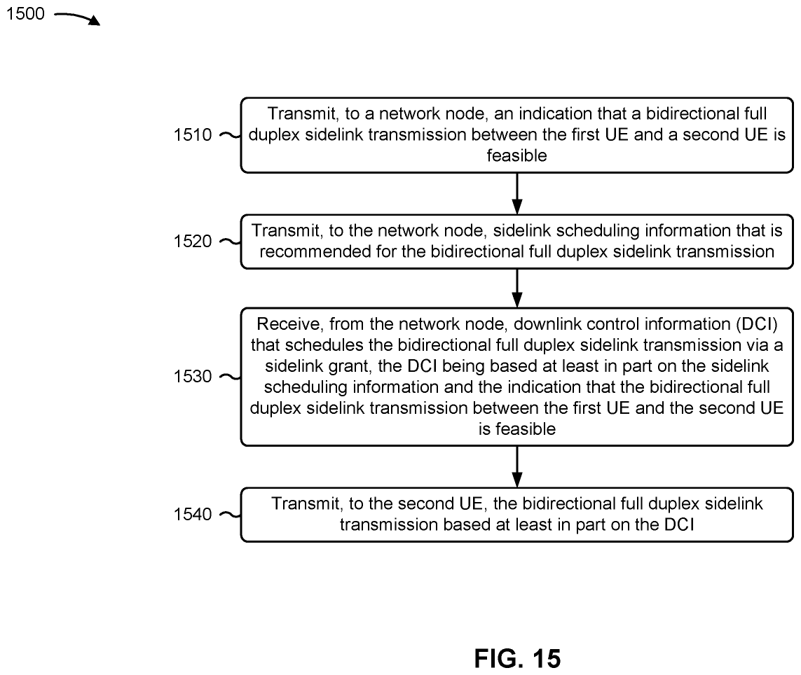

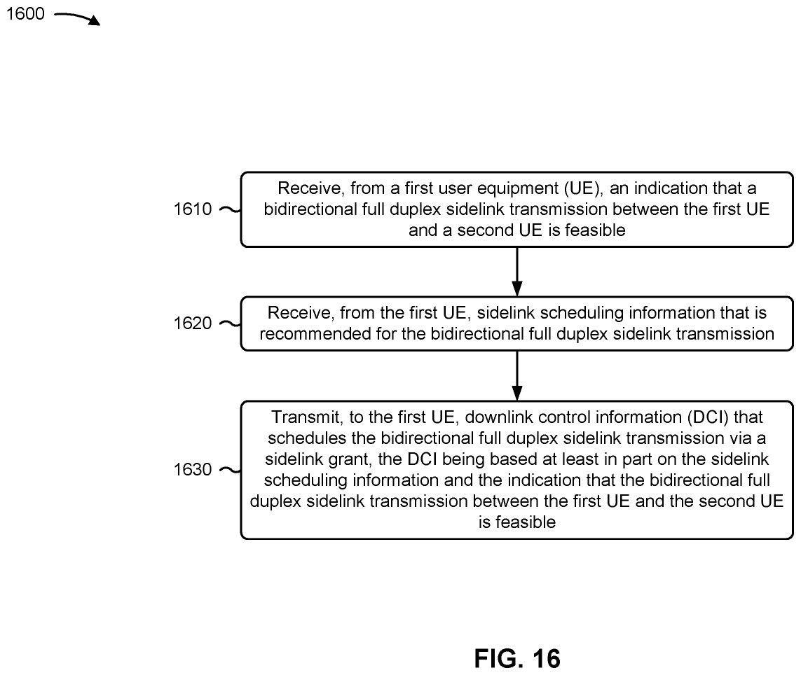

The controller/processor 240 of the network node 110, the controller/processor 280 of the UE 120, and/or any other component(s) of FIG. 2 may perform one or more techniques associated with UE-assisted bidirectional full duplex sidelink transmissions, as described in more detail elsewhere herein. For example, the controller/processor 240 of the network node 110, the controller/processor 280 of the UE 120, and/or any other component(s) of FIG. 2 may perform or direct operations of, for example, process 1500 of FIG. 15, process 1600 of FIG. 16, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, a first UE (e.g., UE 120a) includes means for transmitting, to a network node, an indication that a bidirectional full duplex sidelink transmission between the first UE and a second UE is feasible; means for transmitting, to the network node, sidelink scheduling information that is recommended for the bidirectional full duplex sidelink transmission; means for receiving, from the network node, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible; and/or means for transmitting, to the second UE, the bidirectional full duplex sidelink transmission based at least in part on the DCI. The means for the first UE to perform operations described herein may include, for example, one or more of communication manager 140, antenna 252, modem 254, MIMO detector 256, receive processor 258, transmit processor 264, Tx MIMO processor 266, controller/processor 280, or memory 282.

In some aspects, a network node (e.g., the network node 110) includes means for receiving, from a first UE, an indication that a bidirectional full duplex sidelink transmission between the first UE and a second UE is feasible; means for receiving, from the first UE, sidelink scheduling information that is recommended for the bidirectional full duplex sidelink transmission; and/or means for transmitting, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible. The means for the network node to perform operations described herein may include, for example, one or more of communication manager 150, transmit processor 220, Tx MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

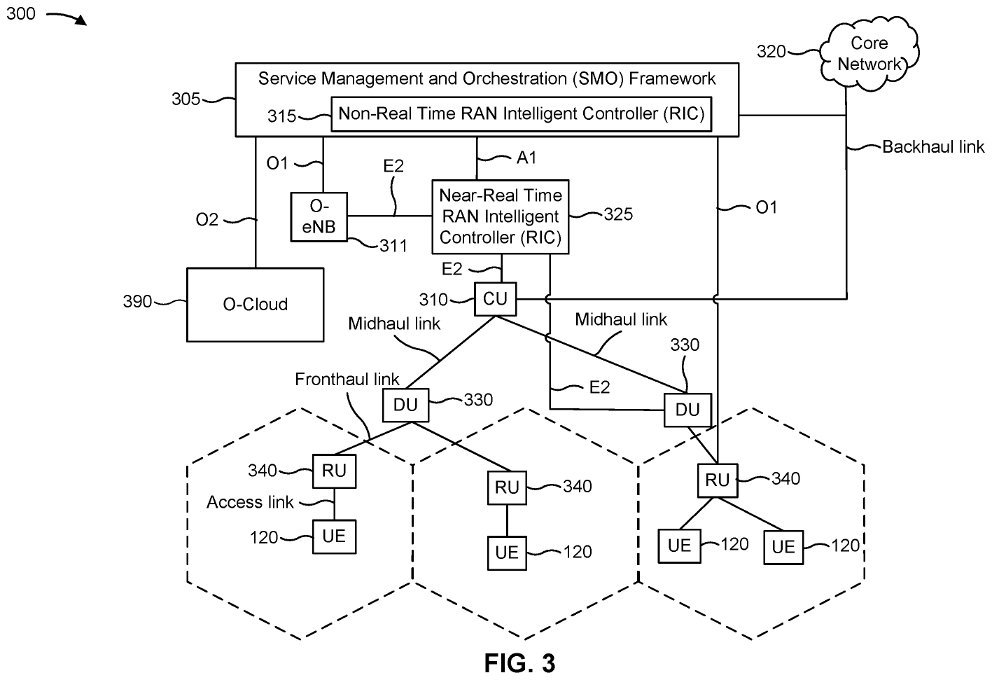

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

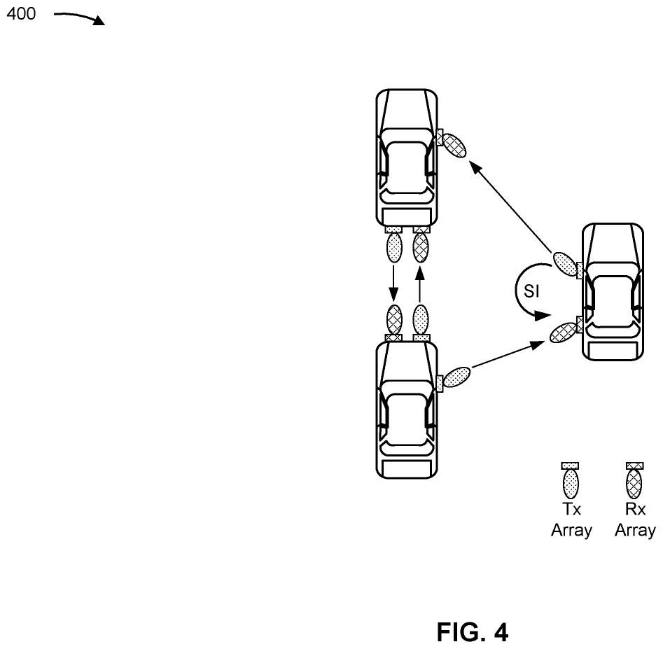

FIG. 4 is a diagram illustrating an example 400 of full duplex in a V2X system, in accordance with the present disclosure.

As shown in FIG. 4, in V2X, a vehicle or a roadside unit (RSU) may have space to ensure sufficient spatial isolation between a Tx panel/array and a receive (Rx) panel/array. For example, a Tx array and an Rx array on the vehicle/RSU may be separated by a certain distance, which may ensure the sufficient spatial isolation. In FR2 and FRx, an amount of self-interference may be reduced due to a relatively large beamforming gain with a relatively large quantity of antenna elements per panel/array. Full duplex communications (e.g., simultaneous transmissions and receptions) may be feasible for an IAB node, a repeater, a network node (e.g., gNB), and/or a UE.

As indicated above, FIG. 4 is provided as an example. Other examples may differ from what is described with regard to FIG. 4.

Sidelink bidirectional full duplex communications may involve at least one UE in network coverage. In a first scenario, two UEs (e.g., two sidelink UEs) may be in network coverage. Each UE may operate in Mode 1 (e.g., sidelink resources are scheduled by a network node). In a second scenario, one UE may be in network coverage, while another UE may be outside of network coverage. An in-coverage UE may operate in Mode 1, while an out-of-coverage (OOC) UE may operate in Mode 2 (e.g., the UE may select its own sidelink resources based at least in part on sensing).

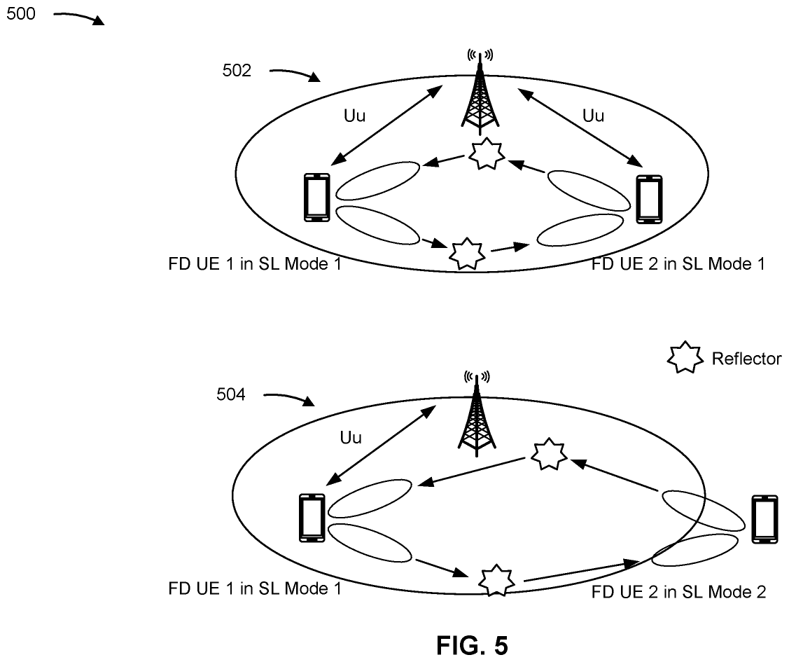

FIG. 5 is a diagram illustrating an example 500 of sidelink bidirectional full duplex communications, in accordance with the present disclosure.

As shown by reference number 502, two UEs may be in network coverage. A first UE (e.g., full duplex (FD) UE 1 in sidelink (SL) Mode 1) may communicate with a network node via a Uu interface. A second UE (e.g., FD UE 2 in SL Mode 1) may communicate with the network node via a Uu interface. The first UE may communicate directly with the second UE. In some cases, the first UE and the second UE may communicate with each other via a wireless channel containing one or more reflectors.

As shown by reference number 504, one UE may be out of network coverage. A first UE (e.g., FD UE 1 in SL Mode 1) may communicate with a network node via a Uu interface. A second UE (e.g., FD UE 2 in SL Mode 2) may be unable to communicate with the network node. The second UE may be an OOC UE. The first UE may communicate directly with the second UE. In some cases, the first UE and the second UE may communicate with each other via a wireless channel containing one or more reflectors.

As indicated above, FIG. 5 is provided as an example. Other examples may differ from what is described with regard to FIG. 5.

When two UEs are in Mode 1, a bidirectional sidelink full duplex may be achieved by a network node scheduling, for the two UEs, overlapped sidelink transmissions. Due to the varying environment around each UE, the network node may need to track whether a full duplex relay is feasible at each UE. Full duplex may not be feasible when relatively strong self-interference is caused from a reflector near the UE, or when both a sidelink transmission and a sidelink reception have to use the same UE panel.

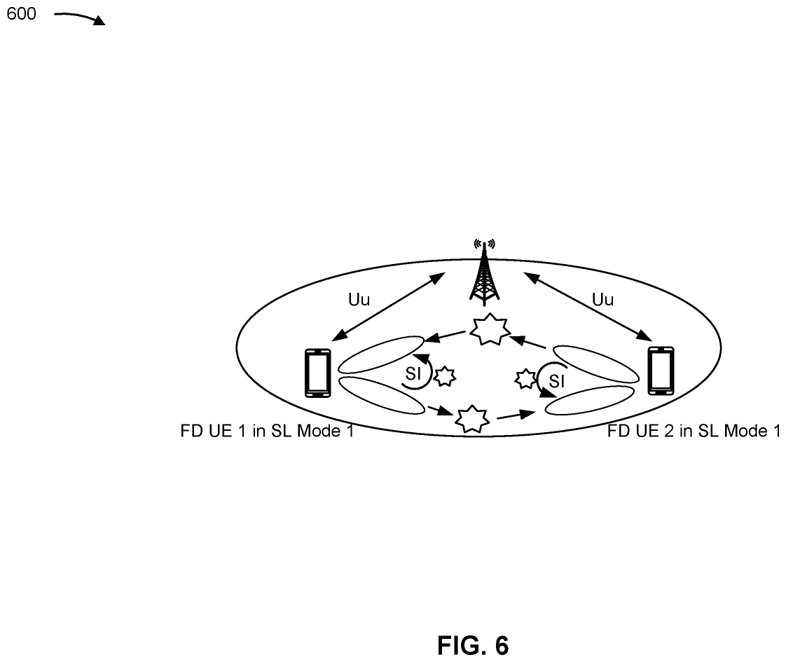

FIG. 6 is a diagram illustrating an example 600 of self-interference associated with a UE, in accordance with the present disclosure.

As shown in FIG. 6, two UEs may be in network coverage. A first UE (e.g., FD UE 1 in SL Mode 1) may communicate with a network node via a Uu interface. A second UE (e.g., FD UE 2 in SL Mode 1) may communicate with the network node via a Uu interface. The first UE may communicate directly with the second UE. In some cases, the first UE and the second UE may communicate with each other via one or more reflectors. Full duplex relaying may not be feasible at the UEs when reflectors near the UEs cause a relatively strong self-interference. For example, a reflector near the first UE may cause a relatively strong self-interference for the first UE, and/or a reflector near the second UE may cause a relatively strong self-interference for the second UE.

A transmission of the first UE, using a first set of antennas, may cause self-interference to a simultaneous reception of the first UE, using a second set of antennas. The first UE may measure a self-interference power during an ongoing transmission and evaluate whether the self-interference is less than a threshold, or a similar metric e.g., whether a signal-to-interference-plus-noise ratio (SINR) is greater than a threshold. The first UE may measure and evaluate the self-interference for multiple transmit-receive beam pairs (only one beam pair is shown in FIG. 6), with one or more second UEs, on different time-frequency resources and/or using different transmission parameters. Based at least in part on the evaluation, the first UE may decide on the feasibility of full-duplexed communication with the second UE and some preferred full duplex sidelink scheduling information. A similar process may be performed by the second UE.

As indicated above, FIG. 6 is provided as an example. Other examples may differ from what is described with regard to FIG. 6.

A network node may need to determine whether a bidirectional sidelink full duplex is feasible for two sidelink full duplex UEs. The network node may determine a sidelink full duplex feasibility, for example, via collecting full duplex performance related metrics from each UE, but such an approach may have a non-negligible impact on overhead and latency. In other words, determining the sidelink full duplex feasibility by collecting the full duplex performance related metrics from each UE may increase a signaling overhead, thereby degrading an overall network performance.

In various aspects of techniques and apparatuses described herein, a first UE may transmit, to a network node, an indication that a bidirectional full duplex sidelink transmission between the first UE and a second UE is feasible. The first UE may be able to determine that the bidirectional full duplex sidelink transmission is feasible based at least in part on a self-interference measurement. The first UE may transmit, to the network node, sidelink scheduling information that is recommended for the bidirectional full duplex sidelink transmission. The first UE may receive, from the network node, DCI that schedules the bidirectional full duplex sidelink transmission via a sidelink grant. The DCI may be based at least in part on the sidelink scheduling information and the indication that the bidirectional full duplex sidelink transmission between the first UE and the second UE is feasible. The first UE may transmit, to the second UE, the bidirectional full duplex sidelink transmission based at least in part on the DCI.

In some aspects, rather than the network node determining a sidelink full duplex feasibility by collecting full duplex performance related metrics from each sidelink UE, which would otherwise increase a signaling overhead and a latency, sidelink UEs may instead inform the network node of the sidelink full duplex feasibility. Such an approach may improve the signaling overhead and the latency, thereby improving an overall performance of the first UE and/or the network node.

FIG. 7 is a diagram illustrating an example 700 associated with UE-assisted bidirectional full duplex sidelink transmissions, in accordance with the present disclosure. As shown in FIG. 7, example 700 includes communication between a first UE (e.g., UE 120a), a second UE (e.g., UE 120e), and a network node (e.g., network node 110). In some aspects, the first UE, the second UE, and the network node may be included in a wireless network, such as wireless network 100.

In some aspects, the first UE and the second UE may be in-coverage UEs. The first UE and the second UE may both be within a coverage area of the network node.

As shown by reference number 702, the first UE may transmit, to the network node, an indication that a bidirectional full duplex sidelink transmission between the first UE and the second UE is feasible. The bidirectional full duplex sidelink transmission may be between the first UE and the second UE. The first UE may determine that the bidirectional full duplex sidelink transmission is feasible based at least in part on a self-interference measurement. The self-interference measurement may be based at least in part on a traffic transmission associated with the first UE or a dedicated reference signal. In some cases, the indication may indicate multiple neighbor UEs for which bidirectional full duplex sidelink transmissions are feasible. Each neighbor UE, of the multiple neighbor UEs, may be identified by a corresponding UE identifier. The first UE may transmit the indication that the bidirectional full duplex sidelink transmission between the first UE and the second UE is feasible based at least in part on a network node scheduled report, a first UE autonomous report, or an event triggered report.

As shown by reference number 704, the first UE may transmit, to the network node, sidelink scheduling information that is recommended for the bidirectional full duplex sidelink transmission. The sidelink scheduling information may indicate a sidelink time-frequency resource for a sidelink grant, which may be relative information between two allocated sidelink resources associated with two sidelink grants for the first UE and the second UE. The relative information may indicate whether the two allocated sidelink resources are non-overlapping in frequency, partially overlapping in frequency, or fully overlapping in frequency. The first UE may transmit the sidelink scheduling information based at least in part on a network node scheduled report, a first UE autonomous report, or an event triggered report.

In some aspects, the sidelink scheduling information may indicate non-time-frequency allocation information for a sidelink resource associated with the sidelink grant. The non-time-frequency allocation information may indicate a sidelink transmit beam, a transmission configuration indicator (TCI) identifier, power information, timing information, ranking information, precoding matrix information, a MIMO scheme, and/or a multiple transmission reception point (mTRP) scheme. The sidelink scheduling information may indicate candidate combinations of sidelink TCI states of both the first UE and the second UE.

In some aspects, the sidelink scheduling information may be a partial sidelink scheduling information. Remaining sidelink scheduling information may be exchanged between the first UE and the second UE via an inter-UE coordination signaling. The remaining sidelink scheduling information may be autonomously applied by the first UE for the bidirectional full duplex sidelink transmission. The partial sidelink scheduling information may indicate a sidelink time-frequency resource for the sidelink grant, which may be relative information between two allocated sidelink resources associated with two sidelink grants for the first UE and the second UE. The relative information may indicate whether the two allocated sidelink resources are non-overlapping in frequency, partially overlapping in frequency, or fully overlapping in frequency. The remaining sidelink scheduling information may indicate non-time-frequency allocation information for a sidelink resource associated with the sidelink grant. The non-time-frequency allocation information may indicate a sidelink transmit beam, a TCI identifier, power information, timing information, ranking information, precoding matrix information, a MIMO scheme, and/or an mTRP scheme. The remaining sidelink scheduling information may indicate candidate combinations of sidelink TCI states of both the first UE and the second UE, where the bidirectional full duplex sidelink transmission may be transmitted based at least in part on the candidate combinations of sidelink TCI states.

In some aspects, the sidelink scheduling information may indicate a set of full duplex Tx and Rx beams associated with the first UE. The set of full duplex Tx and Rx beams may indicate at least one Tx beam to at least one neighbor UE and at least one Rx beam for at least one neighbor UE. Each Tx beam or Rx beam may be identified by a reference signal identifier or a TCI identifier. The sidelink scheduling information may indicate a preferred mTRP scheme or a multiple panel Tx or Rx scheme. The sidelink scheduling information may indicate other scheduling information per Tx beam or Rx beam per neighbor UE. The other scheduling information may indicate a time-frequency resource, power information, timing information, ranking information, precoding matrix information, and/or a MIMO scheme.

As shown by reference number 706, the first UE may receive, from the network node, DCI that schedules the bidirectional full duplex sidelink transmission via the sidelink grant. The DCI may be based at least in part on the indication that the bidirectional full duplex sidelink transmission between the first UE and the second UE is feasible and the sidelink scheduling information. In some cases, the DCI that schedules the bidirectional full duplex sidelink transmission via the sidelink grant may be based at least in part on the candidate combinations of sidelink TCI states.

As shown by reference number 708, the first UE may transmit, to the second UE, the bidirectional full duplex sidelink transmission based at least in part on the DCI, which may be based at least in part on the indication that the bidirectional full duplex sidelink transmission between the first UE and the second UE is feasible and the sidelink scheduling information. The bidirectional full duplex sidelink transmission may be a physical sidelink control channel (PSCCH) transmission or a physical sidelink shared channel (PSSCH) transmission.

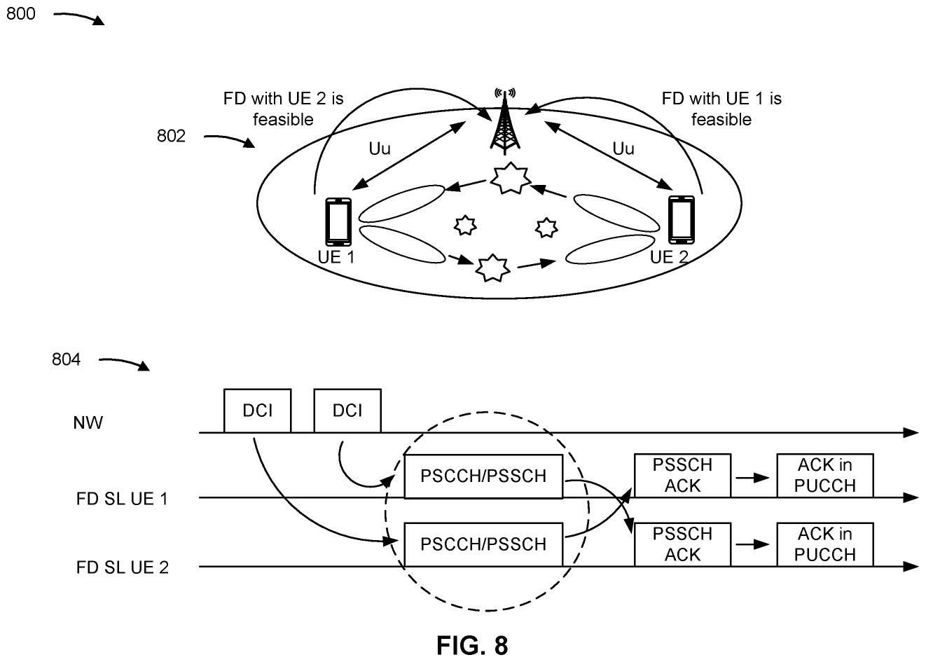

In some aspects, the bidirectional full duplex sidelink transmission may be a first bidirectional full duplex sidelink transmission and the DCI may be a first DCI. The network node may transmit, to the second UE, a second DCI that schedules a second bidirectional full duplex sidelink transmission between the second UE and the first UE (shown in FIG. 8). The first UE may receive, from the second UE, the second bidirectional full duplex sidelink transmission. The first bidirectional full duplex sidelink transmission may overlap in a time domain with the second bidirectional full duplex sidelink transmission. In some cases, the first UE may transmit, to the second UE, a bidirectional full duplex sidelink feedback based at least in part on the candidate combinations of sidelink TCI states. The bidirectional full duplex sidelink feedback may be based at least in part on the second bidirectional full duplex sidelink transmission received from the second UE.

In some aspects, the first UE may be an in-coverage UE, and the second UE may be an OOC UE. The second UE may be outside of a coverage area of the network node.

In some aspects, the first UE may transmit, to the second UE, an indication of selected resources associated with the first bidirectional full duplex sidelink transmission. The first UE may receive, from the second UE, an indication of selected resources associated with the second bidirectional full duplex sidelink transmission.

The first UE may determine time overlapped resources for the first bidirectional full duplex sidelink transmission based at least in part on the selected resources associated with the first bidirectional full duplex sidelink transmission and the selected resources associated with the second bidirectional full duplex sidelink transmission. The first UE may apply full duplex transmit parameters for the time overlapped resources, where the full duplex transmit parameters may indicate a TCI identifier, power information, timing information, ranking information, precoding matrix information, a MIMO scheme, and/or an mTRP scheme.

In some aspects, the first UE may transmit, to the second UE, a request for resources available for the second bidirectional full duplex sidelink transmission associated with the second UE. The first UE may receive, from the second UE, an indication of the resources available for the second bidirectional full duplex sidelink transmission. The first UE may transmit, to the network node, the indication of the resources available for the second bidirectional full duplex sidelink transmission. The first DCI that schedules the first bidirectional full duplex sidelink transmission via the sidelink grant may indicate time overlapped resources for the first bidirectional full duplex sidelink transmission that corresponds to at least some of the resources available for the second bidirectional full duplex sidelink transmission.

In some aspects, the first DCI that schedules the first bidirectional full duplex sidelink transmission via the sidelink grant may indicate resources scheduled for the first bidirectional full duplex sidelink transmission. The first UE may transmit, to the second UE, an indication of the resources scheduled for the first bidirectional full duplex sidelink transmission as a preferred or non-preferred sidelink resources report.

In some aspects, the first UE may receive, from the network node, the second DCI associated with the second UE. The second DCI may indicate a relayed sidelink grant. The first UE may transmit, to the second UE and via sidelink control information (SCI), the relayed sidelink grant. The second UE may transmit, to the first UE, the second bidirectional full duplex sidelink transmission based at least in part on the relayed sidelink grant.

As indicated above, FIG. 7 is provided as an example. Other examples may differ from what is described with regard to FIG. 7.

In some aspects, a UE (e.g., a sidelink UE) may inform a network node whether the UE is able to perform bidirectional full duplex communications with other UE(s), which may enable a UE-assisted sidelink bidirectional full duplex. In other words, the UE may indicate a feasibility of the UE performing bidirectional full duplex communications with other UE(s). The UE may also indicate, to the network node, corresponding recommended sidelink scheduling information. The UE may determine a full duplex feasibility via its self-interference related measurement, which may be based at least in part on the UE's own traffic transmission or based at least in part on a dedicated reference signal.

As an example, a first UE may inform the network node that simultaneous Tx/Rx communication with a second UE is feasible at the first UE, while the second UE may inform the network node that simultaneous Tx/Rx communication with the first UE is feasible at the second UE. In this case, the network node may schedule time overlapped sidelink bidirectional transmissions between the first UE and the second UE.

FIG. 8 is a diagram illustrating an example 800 associated with UE-assisted bidirectional full duplex sidelink transmissions, in accordance with the present disclosure.

As shown by reference number 802, two UEs may be in network coverage. A first UE (e.g., FD UE 1 in SL Mode 1) may communicate with a network node via a Uu interface. A second UE (e.g., FD UE 2 in SL Mode 1) may communicate with the network node via a Uu interface. The first UE may communicate directly with the second UE. In some aspects, the first UE may transmit, to the network node, an indication that a full duplex communication with the second UE is feasible. The second UE may transmit, to the network node, an indication that a full duplex communication with the first UE is feasible. In other words, both UEs may inform the network node of their respective bidirectional full duplex feasibility, which may enable a UE-assisted sidelink bidirectional full duplex.

As shown by reference number 804, a network node (NW) may transmit a first DCI to a second UE (e.g., FD SL UE 2). The network node may transmit a second DCI to a first UE (e.g., FD SL UE 1). The first DCI may schedule a first PSCCH or PSSCH transmission for the second UE. The second UE may schedule a second PSCCH/PSSCH transmission for the first UE. The first PSCCH/PSSCH transmission and the second PSCCH/PSSCH transmission may be simultaneous sidelink bidirectional transmissions. The network node may schedule the simultaneous sidelink bidirectional transmissions via the first DCI and the second DCI, which may be based at least in part on a bidirectional sidelink full duplex being feasible between the first UE and the second UE.

In some aspects, the first UE may receive the second PSCCH/PSSCH transmission from the second UE, and the first UE may transmit a PSSCH acknowledgement (ACK) to the second UE. The second UE may receive the first PSCCH/PSSCH transmission from the first UE, and the second UE may transmit a PSSCH ACK to the first UE. The first PSCCH/PSSCH transmission and the second PSCCH/PSSCH transmission may be simultaneous transmissions, and/or the PSSCH ACKs transmitted by the first UE and the second UE, respectively, may be simultaneous transmissions. In some cases, the first PSCCH/PSSCH transmission and the second PSCCH/PSSCH transmission may be simultaneous transmissions, but the PSSCH ACKs may be scheduled at different times by the network node and thus may not be simultaneous transmissions. Further, the first UE may transmit, to the network node and via a physical uplink control channel (PUCCH) or a physical uplink shared channel (PUSCH), an ACK based at least in part on a receipt of the second DCI. The second UE may transmit, to the network node and via a PUCCH or PUSCH, an ACK based at least in part on a receipt of the first DCI.

As indicated above, FIG. 8 is provided as an example. Other examples may differ from what is described with regard to FIG. 8.

In some aspects, a UE (e.g., a reporting sidelink UE) may report, to a network node, an indication of multiple neighbor UEs with which bidirectional full duplex is feasible. The bidirectional full duplex may be feasible between the UE that reports the indication and the multiple neighbor UEs. Each neighbor UE may be identified by a corresponding layer 2 (L2), layer 1 (L1), or application layer UE identifier. For each reported neighbor UE, the UE may further recommend, to the network node, scheduling information when full duplex bidirectional transmissions are scheduled between these two UEs with two corresponding sidelink grants. The scheduling information may indicate a sidelink time/frequency resource per sidelink grant, which may be relative information between two allocated sidelink resources. The scheduling information may indicate whether the two allocated sidelink resources may be non-overlapping in frequency, partially overlapping in frequency, or fully overlapping in frequency. The scheduling information may indicate, for non-overlapping resources, a required guard band between the two allocated sidelink resources. The scheduling information may indicate, for partially overlapping resources, the allowed overlapping resource blocks between the two allocated sidelink resources. The scheduling information may indicate non-time/frequency allocation related information for sidelink resources per sidelink grant, which may ensure a relatively low self-interference, at least at the UE that is providing the scheduling information. The non-time/frequency allocation related information may indicate a sidelink Tx beam, TCI identifier(s), power information, timing information, rank information, a precoding matrix, and/or a MIMO or multiple TRP (mTRP) scheme.

In some aspects, for a sidelink Tx beam selection for bidirectional full duplex between a first UE and a second UE, the first UE may report, to the network node, candidate combinations of sidelink TCI states of both UEs that may cause relatively low self-interference at the first UE. For example, the first UE may report a first combination of TCI 1 for the first UE and TCI 2 for the second UE, and a second combination of TCI 3 for the first UE and TCI 4 for the second UE. The second UE may report, to the network node, candidate combinations of sidelink TCI states of both UEs that may cause relatively low self-interference at the second UE. For example, the second UE may report a first combination of TCI 3 for the first UE and TCI 4 for the second UE, and a second combination of TCI 5 for the first UE and TCI 6 for the second UE. The network node may receive the candidate combinations of sidelink TCI states from both the first UE and the second UE. The network node may schedule a candidate sidelink TCI combination that is associated with relatively low self-interference at both UEs. For example, the network node may schedule TCI 3 for the first UE and TCI 4 for the second UE, which may be associated with relatively low self-interference at both the first UE and the second UE. By knowing that TCI 3 and TCI 4 are the scheduled TCI states for bidirectional full duplex between the first UE and the second UE, the first and second UEs may determine Tx and Rx beams for bidirectional full duplex between the first UE and the second UE.

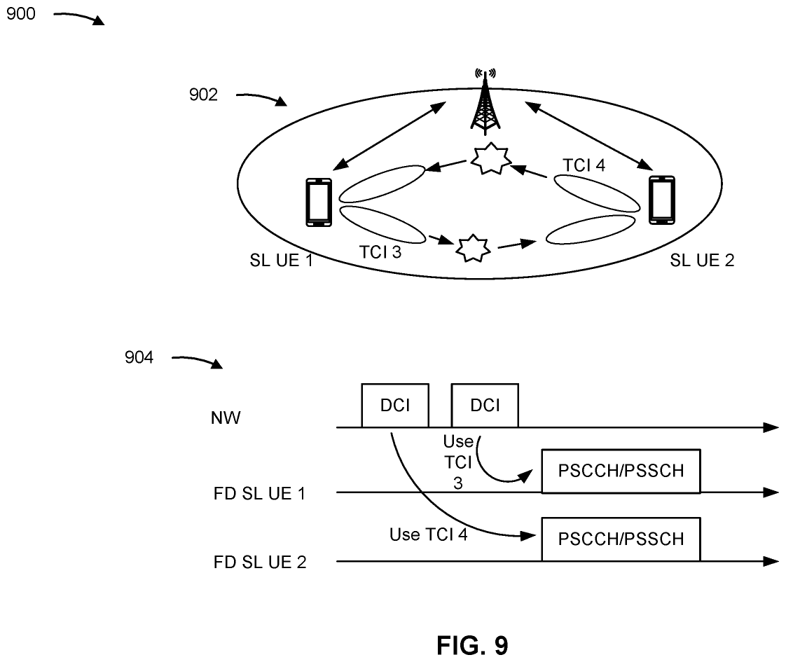

FIG. 9 is a diagram illustrating an example 900 associated with UE-assisted bidirectional full duplex sidelink transmissions, in accordance with the present disclosure.

As shown by reference number 902, a first UE (e.g., SL UE 1) may report, to a network node, candidate combinations of sidelink TCI states. A second UE (e.g., SL UE 2) may report, to the network node, candidate combinations of sidelink TCI states. For example, the candidate combinations of sidelink TCI states reported by the first UE may be {UE 1's TCI 1 and UE 2's TCI 2}, {UE 1's TCI 3 and UE 2's TCI 4}. The candidate combinations of sidelink TCI states reported by the second UE may be {UE 1's TCI 3 and UE 2's TCI 4}, {UE 1's TCI 5 and UE 2's TCI 6}. The network node may schedule a candidate sidelink TCI combination, such as {UE 1's TCI 3 and UE 2's TCI 4}, which may be based at least in part on reporting from the first UE and the second UE. As a result, the first UE may perform a sidelink transmission to the second UE using TCI 3, and the second UE may perform a sidelink transmission to the first UE using TCI 4. The sidelink reception beam at the first UE may be its Rx beam corresponding to TCI 4 of the second UE, and the Rx beam at the second UE may be its Rx beam corresponding to TCI 3 of the first UE.

As shown by reference number 904, a network node (NW) may transmit a first DCI to a second UE. The first DCI may indicate TCI 4. The second UE may transmit, to a first UE, a first PSCCH/PSSCH transmission using TCI 4, which may be based at least in part on the first DCI. The network node may transmit a second DCI to the first UE. The second DCI may indicate TCI 3. The first UE may transmit, to the second UE, a second PSCCH/PSSCH transmission using TCI 3, which may be based at least in part on the second DCI. In other words, the first DCI may instruct the second UE to use TCI 4 for the first PSCCH/PSSCH transmission, and the second DCI may instruct the first UE to use TCI 3 for the second PSCCH/PSSCH transmission. The first PSCCH/PSSCH transmission and the second PSCCH/PSSCH transmission may be simultaneous transmissions.

As indicated above, FIG. 9 is provided as an example. Other examples may differ from what is described with regard to FIG. 9.

In some aspects, a network node may schedule two UEs to use a suitable sidelink TCI combination for a bidirectional full duplex of sidelink feedback, which may be in addition to sidelink traffic (e.g., PSCCH/PSSCH traffic). For example, a first UE may transmit a physical sidelink feedback channel (PSFCH) with TCI 3, and a second UE may transmit a PSFCH with TCI 4.

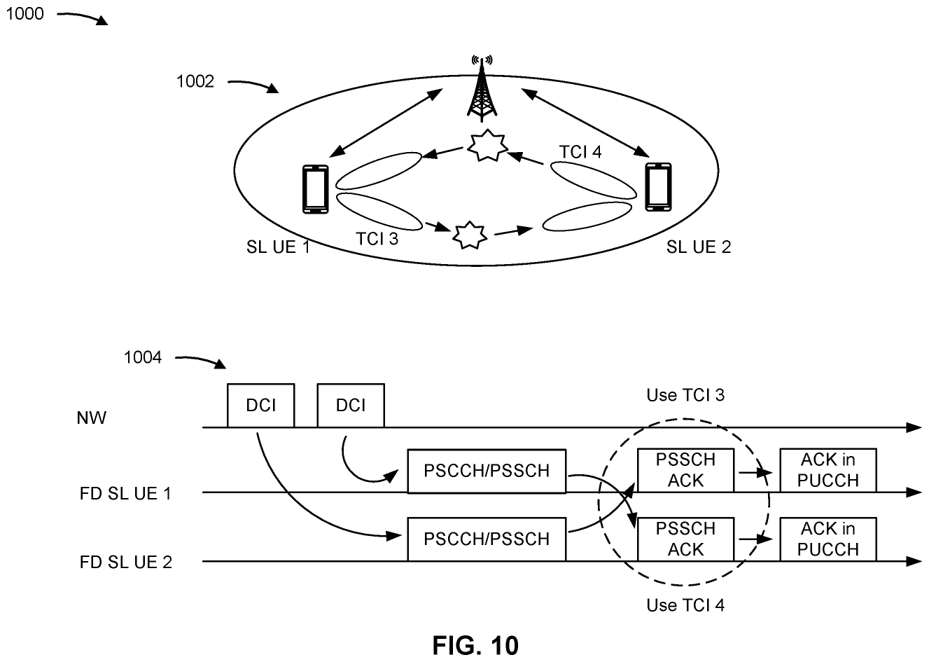

FIG. 10 is a diagram illustrating an example 1000 associated with UE-assisted bidirectional full duplex sidelink transmissions, in accordance with the present disclosure.

As shown by reference number 1002, a first UE (e.g., SL UE 1) may report, to a network node, candidate combinations of sidelink TCI states. A second UE (e.g., SL UE 2) may report, to the network node, candidate combinations of sidelink TCI states. The network node may schedule a candidate sidelink TCI combination, such as {UE 1's TCI 3 and UE 2's TCI 4}, which may be based at least in part on reporting from the first UE and the second UE. As a result, the first UE may perform a sidelink transmission to the second UE using TCI 3, and the second UE may perform a sidelink transmission to the first UE using TCI 4.

As shown by reference number 1004, a network node (NW) may transmit a first DCI to a second UE. The second UE may transmit, to a first UE, a PSCCH/PSSCH transmission based at least in part on the first DCI. The network node may transmit a second DCI to the first UE. The first UE may transmit, to the second UE, a PSCCH/PSSCH transmission based at least in part on the second DCI. The network node may schedule simultaneous sidelink feedback transmissions with full duplex compatible TCIs, which may be based at least in part on the first DCI and the second DCI. The first UE may transmit, to the second UE, a first PSFCH ACK transmission using TCI 3, which may be based at least in part on a network node scheduling. The second UE may transmit, to the first UE, a second PSFCH ACK transmission using TCI 4, which may be based at least in part on a network node scheduling. The first PSFCH ACK transmission and the second PSFCH ACK transmission may be simultaneous transmissions. Further, the first UE may transmit, to the network node and via a PUCCH, an ACK based at least in part on a receipt of the second DCI. The second UE may transmit, to the network node and via a PUCCH, an ACK based at least in part on a receipt of the first DCI.

As indicated above, FIG. 10 is provided as an example. Other examples may differ from what is described with regard to FIG. 10.

In some aspects, a UE may report a basic sidelink scheduling information to a network node, instead of reporting a full scheduling information to the network node.

In other words, instead of reporting all sidelink scheduling information, each UE may only report the basic sidelink scheduling information to the network node. The UE may coordinate with neighbor UEs for remaining sidelink scheduling information, which may be autonomously applied by two UEs when a bidirectional full duplex is scheduled between the two UEs. The remaining sidelink scheduling information may not be reported to the network node, but rather may be applied autonomously by the UEs themselves. The basic sidelink scheduling information may include neighbor UE identifiers, which may be associated with neighbor UEs with which bidirectional full duplex is feasible. The basic sidelink scheduling information may include recommended time/frequency resources for transmissions of the two UEs. The network node may schedule full duplex sidelink time/frequency resources based at least in part on the basic sidelink scheduling information. The remaining sidelink scheduling information may include the UE's Tx beam, TCI identifier(s), power information, timing information, rank information, a precoding matrix, a MIMO/mTRP scheme, and/or other sidelink scheduling parameters. The two UEs may coordinate to exchange the remaining sidelink scheduling information via a sidelink channel (e.g., in a half-duplex mode). The two UEs may exchange inter-UE coordination signaling to indicate the remaining sidelink scheduling information to each other. In this example, the network node may allocate sidelink time/frequency resources, while other non-time/frequency allocation related scheduling information may be determined by transmitting UEs.

In some aspects, for a sidelink Tx beam coordination between two UEs, a first UE may inform a second UE regarding a combination of sidelink TCI states feasible for full duplex at the first UE. For example, the first UE may report a first combination of TCI 1 for the first UE and TCI 2 for the second UE, and a second combination of TCI 3 for the first UE and TCI 4 for the second UE. Based at least in part on the report from the first UE, the second UE may report a combination of sidelink TCI states that is feasible at both the second UE and the first UE. For example, the second UE may report a combination of TCI 3 for the first UE and TCI 4 for the second UE. When scheduling full duplex communications between the first UE and the second UE, a network node may indicate in DCI for the first UE (or the second UE) that a corresponding sidelink grant is intended for bidirectional full duplex communications with the second UE (or the first UE). Based at least in part on the indication, the first UE and the second UE may both apply a coordinated TCI combination (e.g., a combination of TCI 3 for the first UE and TCI 4 for the second UE). The indication in the DCI may indicate an intended neighbor UE identifier for bidirectional full duplex.

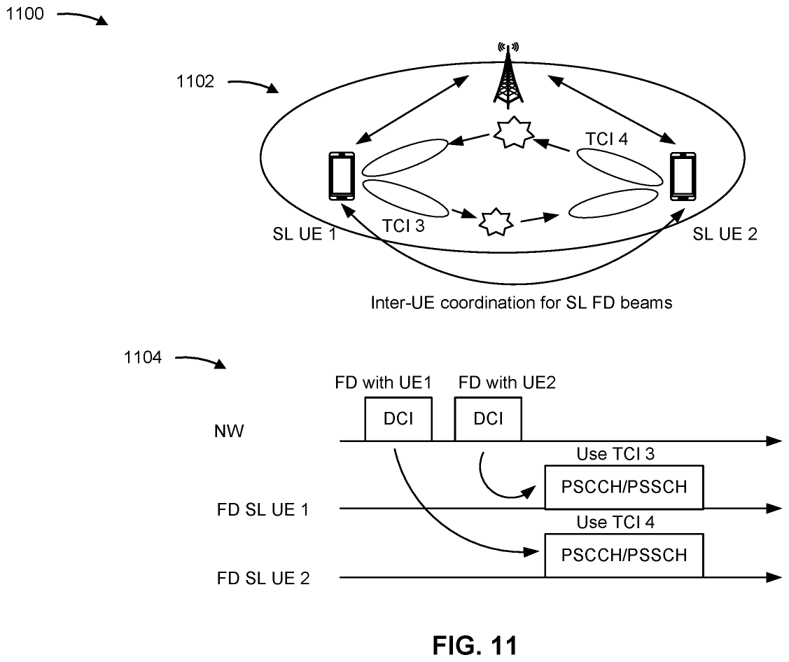

FIG. 11 is a diagram illustrating an example 1100 associated with UE-assisted bidirectional full duplex sidelink transmissions, in accordance with the present disclosure.

As shown by reference number 1102, a first UE (e.g., SL UE 1) may exchange, with a second UE (e.g., SL UE 2), inter-UE coordination for sidelink full duplex beams. For example, the first UE may inform the second UE of combinations of sidelink TCI states that are feasible for full duplex at the first UE. For example, the first UE may report {UE 1's TCI 1 and UE 2's TCI 2}, {UE 1's TCI 3 and UE 2's TCI 4}. The second UE may inform the first UE of a combination of sidelink TCI states that is feasible at both the second UE and the first UE, which may be based at least in part on the report from the first UE. For example, the second UE may report {UE 1's TCI 3+UE 2's TCI 4}.

As shown by reference number 1104, a network node (NW) may transmit a first DCI to a second UE. The first DCI may indicate that a corresponding sidelink grant is intended for a bidirectional full duplex communication with a first UE. The network node may transmit a second DCI to the first UE. The second DCI may indicate that a corresponding sidelink grant is intended for a bidirectional full duplex communication with the second UE. The first UE may perform a first PSCCH/PSSCH transmission, which may be based at least in part on the second DCI. The second UE may perform a second PSCCH/PSSCH transmission, which may be based at least in part on the first DCI. The first UE may perform the first PSCCH/PSSCH transmission using TCI 3, and the second UE may perform the second PSCCH/PSSCH transmission using TCI 4, which may be based at least in part on inter-UE coordination for sidelink full duplex beams exchanged between the first UE and the second UE. Inter-UE coordination may include other types of sidelink scheduling parameters (not shown in FIG. 11) in addition to beams, such as parameters related to power, timing, rank, precoding matrix, and/or MIMO/mTRP scheme.

As indicated above, FIG. 11 is provided as an example. Other examples may differ from what is described with regard to FIG. 11.

In some aspects, a reporting of a UE's feasible full duplex bidirectional Tx/Rx beams with a neighbor UE may be generalized to reporting at least one set of full duplex beams with at least one Tx beam to at least one neighbor UE and at least one Rx beam for at least one neighbor UE. For example, a first UE may report, to a network node, that the first UE is able to simultaneously receive from a second UE with an Rx beam 1 and an Rx beam 2, while transmitting to a third UE with Tx beam 1 and Tx beam 2, and while receiving from a fourth UE with Rx beam 3. Each Tx beam and/or Rx beam may be identified by a reference signal identifier or a TCI identifier transmitted or indicated by either of two UEs involved in sidelink communications with each other. For multiple Tx beams or Rx beams associated with neighbor UEs, the first UE may report, to the network node, a preferred multi-TRP or multi-panel Tx or Rx scheme, such as spatial division multiplexing (SDM) or frequency division multiplexing (FDM) based mTRP transmissions or receptions. The first UE may also indicate, to the network node, a recommendation other scheduling information per Tx/Rx beam and per neighbor UE. The other scheduling information may indicate time/frequency resources, such as non-overlapping resources in a frequency domain, partially overlapping resources in the frequency domain, or fully overlapping resources in the frequency domain. The other scheduling information may indicate power information, timing information, rank information, a precoding matrix, and/or a MIMO/mTRP scheme.

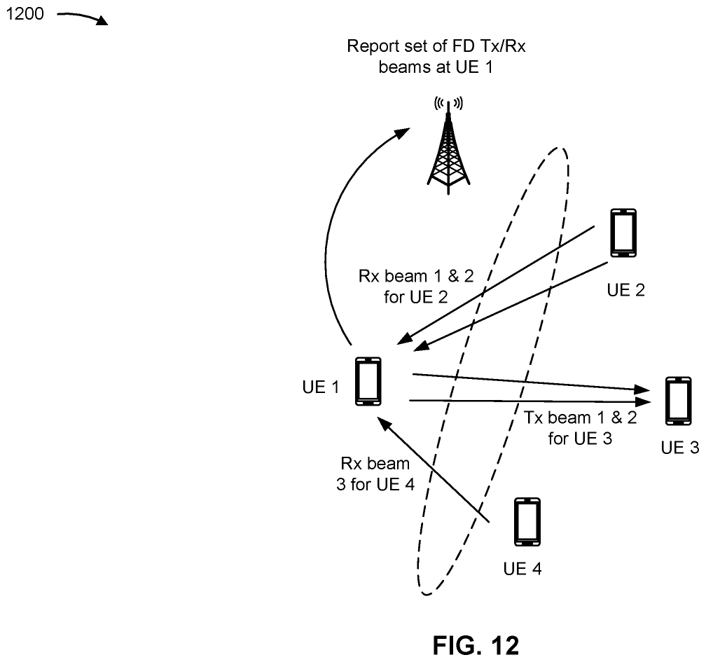

FIG. 12 is a diagram illustrating an example 1200 associated with UE-assisted bidirectional full duplex sidelink transmissions, in accordance with the present disclosure.

As shown in FIG. 12, a first UE may transmit, to a network node, a report that indicates a set of full duplex Tx/Rx beams at the first UE. The report may indicate an Rx beam 1 and an Rx beam 2 for a second UE. The report may indicate a Tx beam 1 and a Tx beam 2 for a third UE. The report may indicate an Rx beam 3 for a fourth UE. The first UE may indicate, via the report, that the first UE is able to simultaneously use Rx beam 1, Rx beam 2, Rx beam 3, Tx beam 1, and Tx beam 2 to communicate with the second UE, the third UE, and the fourth UE, respectively.

As indicated above, FIG. 12 is provided as an example. Other examples may differ from what is described with regard to FIG. 12.

In some aspects, a UE may report, to a network node, UE assistance information associated with a bidirectional full duplex scheduling of the UE. The UE assistance information may enable a UE-assisted sidelink bidirectional full duplex. For example, the UE assistance information may indicate a feasibility of the UE performing bidirectional full duplex communications with other UEs. In some aspects, the UE may indicate the UE assistance information using a network node scheduled report. The network node scheduled report may be a periodic, semi-persistent, or an aperiodic report. The network node scheduled report may be based at least in part on a channel state information (CSI) reporting framework. In some aspects, the UE may indicate the UE assistance information using a UE autonomous report. The UE may transmit the UE autonomous report when a set of full duplex feasible beams/UEs are identified by the UE. In some aspects, the UE may indicate the UE assistance information using an event triggered report, which may be carried in uplink control information (UCI) or a MAC control element (MAC-CE). Events and/or thresholds associated with the event triggered report may be configured by the network node. For example, the event triggered report may be triggered when a self-interference caused from at least one sidelink transmission to at least one sidelink reception is less than a threshold. As another example, the event triggered report may be triggered when an SINR of one sidelink reception considering self-interference from one sidelink transmission is greater than a threshold. A priority may be defined for the UCI or the MAC-CE carrying the full duplex relay assistance when multiplexed with other UCI or MAC-CE types.

In some aspects, in a second scenario, a first UE may be in network coverage, while a second UE may be outside of network coverage. The first UE and the second UE may be sidelink UEs. The first UE may operate in Mode 1, while the second UE, which may be an OOC UE, may operate in Mode 2 (e.g., the second UE may select its own sidelink resources based at least in part on sensing). The second UE may operate in Mode 2 to select time/frequency resources based at least in part on its own sensing. When the first UE operates in Mode 1, the first UE's time/frequency resources may be scheduled by a network node. In the second scenario, the two UEs may determine that full duplex bidirectional transmission between them is feasible (e.g., by using inter-UE full duplex sidelink coordination). The two UEs may need to coordinate on time overlapped resources for bidirectional sidelink transmissions with corresponding full duplex optimized Tx parameters (e.g., beams), even when one of the two UEs is OOC. Further, the network node may need to schedule overlapped sidelink transmissions for the two UEs, even though one of the two UEs may be OOC.

In some aspects, two UEs may identify time overlapped resources and use full duplex optimized Tx parameters for the time overlapped resources. The full duplex optimized Tx parameters may include a Tx beam, power information, timing information, ranking information, a precoding matrix, and/or a MIMO/mTRP scheme. In a first option, the two UEs may exchange information regarding selected resources planned for sidelink transmissions, and based at least in part on the information, the two UEs may be able to identify time overlapped resource occasions. The UEs may then use full duplex optimized Tx parameters for the time overlapped resources. The selected resources may or may not be reserved by the two UEs over the air. In a second option, a first UE (e.g., an in-coverage UE) may request and forward an indication of a resource, as selected by a second UE (e.g., an OOC UE), to a network node. The network node may schedule the first UE's resource to overlap with the second UE's selected resource to maximize a spectrum efficiency. The first UE may inform the second UE of the first UE's overlapped resource after the network node's selection of the overlapped resource. The UEs may then use full duplex optimized Tx parameters for the time overlapped resources. In a third option, the first UE (e.g., the in-coverage UE) may forward an indication of a resource, as selected by the network node, to the second UE (e.g., the OOC UE). The second UE may select its resource to overlap with the first UE's resource to maximize the spectrum efficiency. The second UE may inform the first UE of the second UE's overlapped resource after the second UE's selection of the overlapped resource. The UEs may then use full duplex optimized Tx parameters for the time overlapped resources.

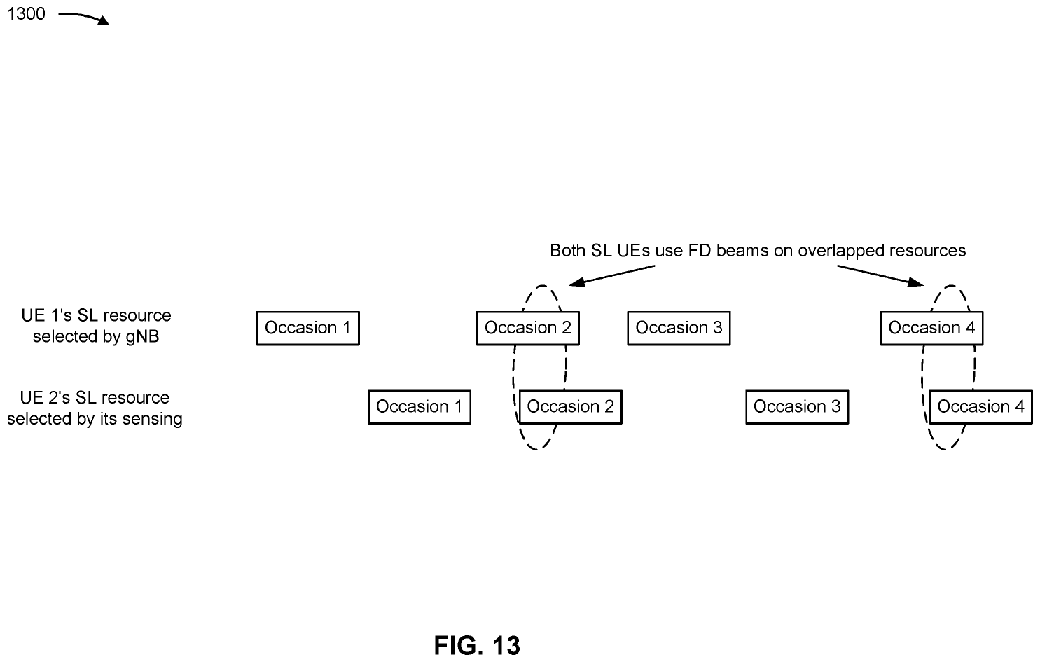

FIG. 13 is a diagram illustrating an example 1300 associated with UE-assisted bidirectional full duplex sidelink transmissions, in accordance with the present disclosure.

As shown in FIG. 13, a first UE (e.g., an in-coverage UE) may be associated with sidelink resources selected by a network node. A second UE (e.g., an OOC UE) may be associated with sidelink resources selected by its sensing. The sidelink resources associated with the first UE may be associated with a plurality of occasions. The sidelink resources associated with the second UE may be associated with a plurality of occasions. The first UE and the second UE may both need to use full duplex beams on overlapped resources. For example, second occasions and fourth occasions of the first UE and the second UE may correspond to overlapped resources, whereas first occasions and third occasions of the first UE and the second UE may not correspond to overlapped resources.

As indicated above, FIG. 13 is provided as an example. Other examples may differ from what is described with regard to FIG. 13.

In some aspects, overlapped full duplex bidirectional sidelink transmissions may be scheduled by a single network node, even when one of two UEs is OOC. The network node may transmit, to a second UE (e.g., an OOC UE), a sidelink grant relayed by a first UE (e.g., an in-coverage UE), whose sidelink resource may be overlapped with that of a sidelink grant sent for the first UE's sidelink transmission. The second UE may operate in a Mode 1′, in which the second UE may receive relayed sidelink grants from the network node. In other words, the second UE may not directly receive the sidelink grant from the network node, but rather may receive the sidelink grant via the first UE. Both sidelink grants may schedule semi-persistent resource to reduce a scheduling overhead, at least in the case of periodic traffic.

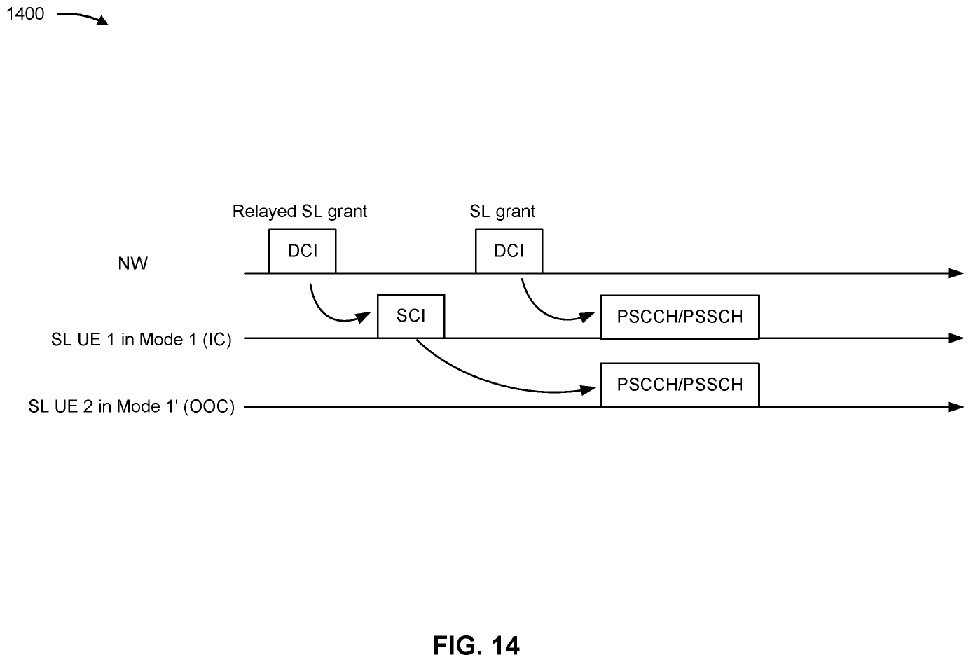

FIG. 14 is a diagram illustrating an example 1400 associated with UE-assisted bidirectional full duplex sidelink transmissions, in accordance with the present disclosure.

As shown in FIG. 14, a network node (NW) may transmit, to a first UE (e.g., SL UE 1 in Mode 1 and in-coverage), a first DCI. The first DCI may indicate a relayed sidelink grant. The first UE may transmit, to a second UE (e.g., SL UE 2 in Mode 1′ and OOC), the relayed sidelink grant. The Mode 1′ may be a mode in which the network node may be able to control some resource allocation for an OOC UE through a relay UE. For example, the first UE may transmit, to the second UE, SCI that indicates the relayed sidelink grant for the second UE. The network node may transmit, to the first UE, a second DCI. The second DCI may indicate a sidelink grant for the first UE. The first UE may perform a first PSCCH/PSSCH transmission, which may be based at least in part on the second DCI with the sidelink grant. The second UE may perform a second PSCCH/PSSCH transmission, which may be based at least in part on the first DCI that indicates the relayed sidelink grant. The first PSCCH/PSSCH transmission and the second PSCCH/PSSCH transmission may be simultaneous transmissions. In other words, the relayed sidelink grant indicated by the first UE and the sidelink grant indicated by the second DCI may correspond to overlapping sidelink resources.

As indicated above, FIG. 14 is provided as an example. Other examples may differ from what is described with regard to FIG. 14.

FIG. 15 is a diagram illustrating an example process 1500 performed, for example, by a first UE, in accordance with the present disclosure. Example process 1500 is an example where the first UE (e.g., UE 120a) performs operations associated with UE-assisted bidirectional full duplex sidelink transmissions.

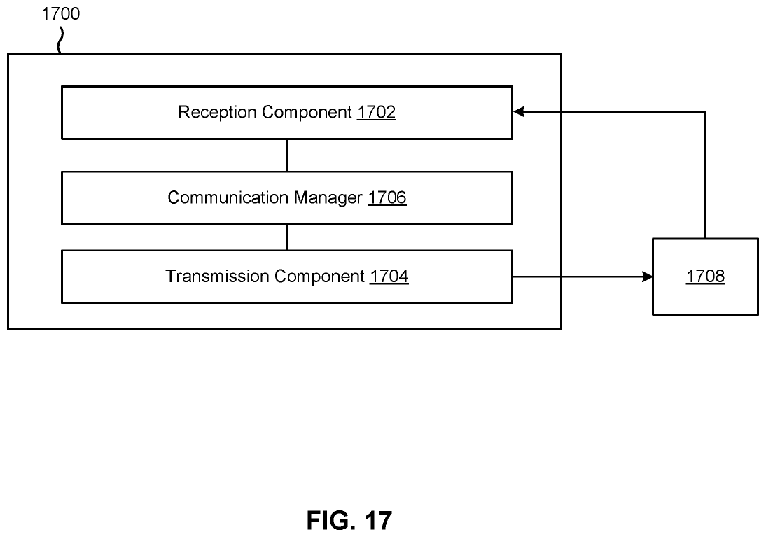

As shown in FIG. 15, in some aspects, process 1500 may include transmitting, to a network node, an indication that a bidirectional full duplex sidelink transmission between the first UE and a second UE is feasible (block 1510). For example, the first UE (e.g., using transmission component 1704 and/or communication manager 1706, depicted in FIG. 17) may transmit, to a network node, an indication that a bidirectional full duplex sidelink transmission between the first UE and a second UE is feasible, as described above.

As further shown in FIG. 15, in some aspects, process 1500 may include transmitting, to the network node, sidelink scheduling information that is recommended for the bidirectional full duplex sidelink transmission (block 1520). For example, the first UE (e.g., using transmission component 1704 and/or communication manager 1706, depicted in FIG. 17) may transmit, to the network node, sidelink scheduling information that is recommended for the bidirectional full duplex sidelink transmission, as described above.

As further shown in FIG. 15, in some aspects, process 1500 may include receiving, from the network node, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible (block 1530). For example, the first UE (e.g., using reception component 1702 and/or communication manager 1706, depicted in FIG. 17) may receive, from the network node, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible, as described above.

As further shown in FIG. 15, in some aspects, process 1500 may include transmitting, to the second UE, the bidirectional full duplex sidelink transmission based at least in part on the DCI (block 1540). For example, the first UE (e.g., using transmission component 1704 and/or communication manager 1706, depicted in FIG. 17) may transmit, to the second UE, the bidirectional full duplex sidelink transmission based at least in part on the DCI, as described above.

Process 1500 may include additional aspects, such as any single aspect or any combination of aspects described below and/or in connection with one or more other processes described elsewhere herein.

In a first aspect, process 1500 includes determining that the bidirectional full duplex sidelink transmission is feasible based at least in part on a self-interference measurement, the self-interference measurement being based at least in part on a traffic transmission associated with the first UE or a dedicated reference signal.

In a second aspect, alone or in combination with the first aspect, the bidirectional full duplex sidelink transmission is a first bidirectional full duplex sidelink transmission and the DCI is a first DCI, a second DCI scheduling a second bidirectional full duplex sidelink transmission between the second UE and the first UE, and the first bidirectional full duplex sidelink transmission overlapping in a time domain with the second bidirectional full duplex sidelink transmission.

In a third aspect, alone or in combination with one or more of the first and second aspects, the bidirectional full duplex sidelink transmission is a PSCCH transmission or a PSSCH transmission.

In a fourth aspect, alone or in combination with one or more of the first through third aspects, the indication indicates multiple neighbor UEs for which bidirectional full duplex sidelink transmissions are feasible, and each neighbor UE, of the multiple neighbor UEs, being identified by a corresponding UE identifier.

In a fifth aspect, alone or in combination with one or more of the first through fourth aspects, the sidelink scheduling information indicates a sidelink time-frequency resource for the sidelink grant, the sidelink scheduling information indicating relative information between two allocated sidelink resources associated with two sidelink grants for the first UE and the second UE, and the sidelink scheduling information indicating whether the two allocated sidelink resources are non-overlapping in frequency, partially overlapping in frequency, or fully overlapping in frequency.

In a sixth aspect, alone or in combination with one or more of the first through fifth aspects, the sidelink scheduling information indicates non-time-frequency allocation information for a sidelink resource associated with the sidelink grant, and the non-time-frequency allocation information indicates one or more of a sidelink transmit beam, a TCI identifier, power information, timing information, ranking information, precoding matrix information, a MIMO scheme, or an mTRP scheme.

In a seventh aspect, alone or in combination with one or more of the first through sixth aspects, the sidelink scheduling information indicates candidate combinations of sidelink TCI states of both the first UE and the second UE.

In an eighth aspect, alone or in combination with one or more of the first through seventh aspects, the DCI that schedules the bidirectional full duplex sidelink transmission via the sidelink grant is based at least in part on the candidate combinations of sidelink TCI states.

In a ninth aspect, alone or in combination with one or more of the first through eighth aspects, process 1500 includes transmitting, to the second UE, a bidirectional full duplex sidelink feedback based at least in part on the candidate combinations of sidelink TCI states.

In a tenth aspect, alone or in combination with one or more of the first through ninth aspects, the sidelink scheduling information is a partial sidelink scheduling information, remaining sidelink scheduling information being exchanged between the first UE and the second UE via an inter-UE coordination signaling, and the remaining sidelink scheduling information being autonomously applied by the first UE for the bidirectional full duplex sidelink transmission.

In an eleventh aspect, alone or in combination with one or more of the first through tenth aspects, the partial sidelink scheduling information indicates a sidelink time-frequency resource for the sidelink grant, the partial sidelink scheduling information indicating relative information between two allocated sidelink resources associated with two sidelink grants for the first UE and the second UE, and the partial sidelink scheduling information indicating whether the two allocated sidelink resources are non-overlapping in frequency, partially overlapping in frequency, or fully overlapping in frequency, and the remaining sidelink scheduling information indicates non-time-frequency allocation information for a sidelink resource associated with the sidelink grant, and the non-time-frequency allocation information indicating one or more of a sidelink transmit beam, a TCI identifier, power information, timing information, ranking information, precoding matrix information, a MIMO scheme, or an mTRP scheme.

In a twelfth aspect, alone or in combination with one or more of the first through eleventh aspects, the remaining sidelink scheduling information indicates candidate combinations of sidelink TCI states of both the first UE and the second UE, and the bidirectional full duplex sidelink transmission being transmitted based at least in part on the candidate combinations of sidelink TCI states.

In a thirteenth aspect, alone or in combination with one or more of the first through twelfth aspects, the sidelink scheduling information indicating a set of full duplex transmit and receive beams associated with the first UE, the set of full duplex transmit and receive beams indicating at least one transmit beam to at least one neighbor UE and at least one receive beam for at least one neighbor UE, and each transmit beam or receive beam being identified by a reference signal identifier or a TCI identifier.

In a fourteenth aspect, alone or in combination with one or more of the first through thirteenth aspects, the sidelink scheduling information indicates a preferred mTRP scheme or a multiple panel transmit or receive scheme.

In a fifteenth aspect, alone or in combination with one or more of the first through fourteenth aspects, the sidelink scheduling information indicates other scheduling information per transmit beam or receive beam per neighbor UE, and the other scheduling information indicating one or more of a time-frequency resource, power information, timing information, ranking information, precoding matrix information, or a MIMO scheme.

In a sixteenth aspect, alone or in combination with one or more of the first through fifteenth aspects, process 1500 includes transmitting one or more of the indication that the bidirectional full duplex sidelink transmission between the first UE and the second UE is feasible or the sidelink scheduling information based at least in part on one of a network node scheduled report, a first UE autonomous report, or an event triggered report.

In a seventeenth aspect, alone or in combination with one or more of the first through sixteenth aspects, the bidirectional full duplex sidelink transmission is a first bidirectional full duplex sidelink transmission, and process 1500 includes transmitting, to the second UE, an indication of selected resources associated with the first bidirectional full duplex sidelink transmission, receiving, from the second UE, an indication of selected resources associated with a second bidirectional full duplex sidelink transmission, determining time overlapped resources for the first bidirectional full duplex sidelink transmission based at least in part on the selected resources associated with the first bidirectional full duplex sidelink transmission and the selected resources associated with the second bidirectional full duplex sidelink transmission, and applying full duplex transmit parameters for the time overlapped resources, the full duplex transmit parameters indicating one or more of a TCI identifier, power information, timing information, ranking information, precoding matrix information, a MIMO scheme, or an mTRP scheme.

In an eighteenth aspect, alone or in combination with one or more of the first through seventeenth aspects, the bidirectional full duplex sidelink transmission is a first bidirectional full duplex sidelink transmission, and process 1500 includes transmitting, to the second UE, a request for resources available for a second bidirectional full duplex sidelink transmission associated with the second UE, receiving, from the second UE, an indication of the resources available for the second bidirectional full duplex sidelink transmission, and transmitting, to the network node, the indication of the resources available for the second bidirectional full duplex sidelink transmission, the DCI that schedules the first bidirectional full duplex sidelink transmission via the sidelink grant indicating time overlapped resources for the first bidirectional full duplex sidelink transmission that corresponds to at least some of the resources available for the second bidirectional full duplex sidelink transmission.

In a nineteenth aspect, alone or in combination with one or more of the first through eighteenth aspects, the bidirectional full duplex sidelink transmission is a first bidirectional full duplex sidelink transmission, the DCI that schedules the first bidirectional full duplex sidelink transmission via the sidelink grant indicating resources scheduled for the first bidirectional full duplex sidelink transmission, and process 1500 includes transmitting, to the second UE, an indication of the resources scheduled for the first bidirectional full duplex sidelink transmission as a preferred or non-preferred sidelink resources report.

In a twentieth aspect, alone or in combination with one or more of the first through nineteenth aspects, the DCI is a first DCI and the bidirectional full duplex sidelink transmission is a first bidirectional full duplex sidelink transmission, and process 1500 includes receiving, from the network node, a second DCI associated with the second UE, the second DCI indicating a relayed sidelink grant for the second UE, transmitting, to the second UE and via SCI, the relayed sidelink grant, and receiving, from the second UE, a second bidirectional full duplex sidelink transmission based at least in part on the relayed sidelink grant.

In a twenty-first aspect, alone or in combination with one or more of the first through twentieth aspects, the first UE and the second UE are in-coverage UEs, or the first UE is an in-coverage UE and the second UE is an OOC UE.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network node, in accordance with the present disclosure. Example process 1600 is an example where the network node (e.g., network node 110) performs operations associated with UE-assisted bidirectional full duplex sidelink transmissions.

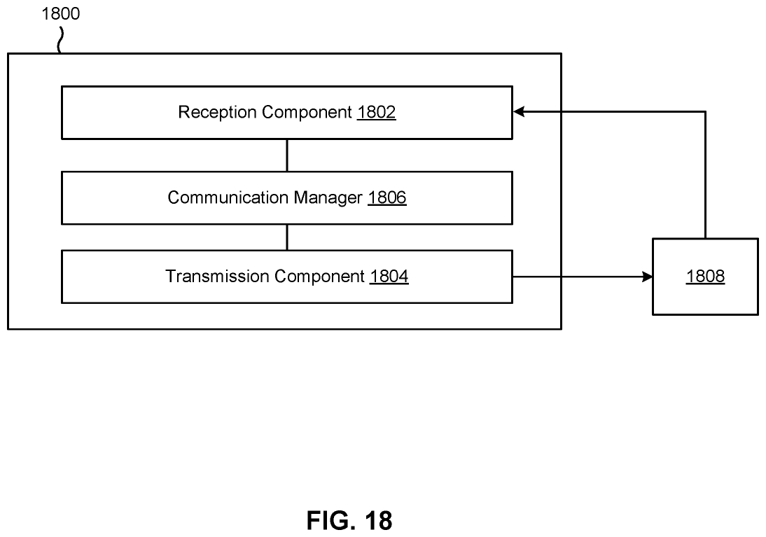

As shown in FIG. 16, in some aspects, process 1600 may include receiving, from a first UE, an indication that a bidirectional full duplex sidelink transmission between the first UE and a second UE is feasible (block 1610). For example, the network node (e.g., using reception component 1802 and/or communication manager 1806, depicted in FIG. 18) may receive, from a first UE, an indication that a bidirectional full duplex sidelink transmission between the first UE and a second UE is feasible, as described above.

As further shown in FIG. 16, in some aspects, process 1600 may include receiving, from the first UE, sidelink scheduling information that is recommended for the bidirectional full duplex sidelink transmission (block 1620). For example, the network node (e.g., using reception component 1802 and/or communication manager 1806, depicted in FIG. 18) may receive, from the first UE, sidelink scheduling information that is recommended for the bidirectional full duplex sidelink transmission, as described above.

As further shown in FIG. 16, in some aspects, process 1600 may include transmitting, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible (block 1630). For example, the network node (e.g., using transmission component 1804 and/or communication manager 1806, depicted in FIG. 18) may transmit, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible, as described above.

Process 1600 may include additional aspects, such as any single aspect or any combination of aspects described below and/or in connection with one or more other processes described elsewhere herein.

In a first aspect, the bidirectional full duplex sidelink transmission between the first UE and the second UE is feasible based at least in part on a self-interference measurement.

In a second aspect, alone or in combination with the first aspect, the bidirectional full duplex sidelink transmission is a first bidirectional full duplex sidelink transmission and the DCI is a first DCI, and further comprising transmitting, to the second UE, a second DCI that schedules a second bidirectional full duplex sidelink transmission between the second UE and the first UE, and the first bidirectional full duplex sidelink transmission overlaps in a time domain with the second bidirectional full duplex sidelink transmission.

In a third aspect, alone or in combination with one or more of the first and second aspects, the bidirectional full duplex sidelink transmission is a PSCCH transmission or a PSSCH transmission.

In a fourth aspect, alone or in combination with one or more of the first through third aspects, the indication indicates multiple neighbor UEs for which bidirectional full duplex sidelink transmissions are feasible, and each neighbor UE, of the multiple neighbor UEs, being identified by a corresponding UE identifier.

In a fifth aspect, alone or in combination with one or more of the first through fourth aspects, the sidelink scheduling information indicates a sidelink time-frequency resource for the sidelink grant, the sidelink scheduling information indicating relative information between two allocated sidelink resources associated with two sidelink grants for the first UE and the second UE, and the sidelink scheduling information indicating whether the two allocated sidelink resources are non-overlapping in frequency, partially overlapping in frequency, or fully overlapping in frequency.

In a sixth aspect, alone or in combination with one or more of the first through fifth aspects, the sidelink scheduling information indicates non-time-frequency allocation information for a sidelink resource associated with the sidelink grant, and the non-time-frequency allocation information indicating one or more of a sidelink transmit beam, a TCI identifier, power information, timing information, ranking information, precoding matrix information, a MIMO scheme, or an mTRP scheme.

In a seventh aspect, alone or in combination with one or more of the first through sixth aspects, the sidelink scheduling information indicates candidate combinations of sidelink TCI states of both the first UE and the second UE.

In an eighth aspect, alone or in combination with one or more of the first through seventh aspects, the sidelink scheduling information is a partial sidelink scheduling information, remaining sidelink scheduling information being exchanged between the first UE and the second UE via an inter-UE coordination signaling, and the remaining sidelink scheduling information being autonomously applied by the first UE for the bidirectional full duplex sidelink transmission.

In a ninth aspect, alone or in combination with one or more of the first through eighth aspects, the partial sidelink scheduling information indicates a sidelink time-frequency resource for the sidelink grant, the partial sidelink scheduling information indicating relative information between two allocated sidelink resources associated with two sidelink grants for the first UE and the second UE, and the partial sidelink scheduling information indicating whether the two allocated sidelink resources are non-overlapping in frequency, partially overlapping in frequency, or fully overlapping in frequency, and the remaining sidelink scheduling information indicates non-time-frequency allocation information for a sidelink resource associated with the sidelink grant, and the non-time-frequency allocation information indicating one or more of a sidelink transmit beam, a TCI identifier, power information, timing information, ranking information, precoding matrix information, a MIMO scheme, or an mTRP scheme.

In a tenth aspect, alone or in combination with one or more of the first through ninth aspects, the remaining sidelink scheduling information indicates candidate combinations of sidelink TCI states of both the first UE and the second UE, and the bidirectional full duplex sidelink transmission being transmitted based at least in part on the candidate combinations of sidelink TCI states.

In an eleventh aspect, alone or in combination with one or more of the first through tenth aspects, the sidelink scheduling information indicating a set of full duplex transmit and receive beams associated with the first UE, the set of full duplex transmit and receive beams indicating at least one transmit beam to at least one neighbor UE and at least one receive beam for at least one neighbor UE, and each transmit beam or receive beam being identified by a reference signal identifier or a TCI identifier.

In a twelfth aspect, alone or in combination with one or more of the first through eleventh aspects, the sidelink scheduling information indicates a preferred mTRP scheme or a multiple panel transmit or receive scheme.

In a thirteenth aspect, alone or in combination with one or more of the first through twelfth aspects, the sidelink scheduling information indicates other scheduling information per transmit beam or receive beam per neighbor UE, and the other scheduling information indicating one or more of a time-frequency resource, power information, timing information, ranking information, precoding matrix information, or a MIMO scheme.

In a fourteenth aspect, alone or in combination with one or more of the first through thirteenth aspects, the DCI is a first DCI, and process 1600 includes transmitting, to the first UE, a second DCI associated with the second UE, the second DCI indicating a relayed sidelink grant for the second UE.

In a fifteenth aspect, alone or in combination with one or more of the first through fourteenth aspects, the first UE and the second UE are in-coverage UEs, or the first UE is an in-coverage UE and the second UE is an OOC UE.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a first UE, or a first UE may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 140 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 7-14. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the first UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the first UE described in connection with FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, a modem, a modulator, a transmit MIMO processor, a transmit processor, a controller/processor, a memory, or a combination thereof, of the first UE described in connection with FIG. 2. In some aspects, the transmission component 1704 may be co-located with the reception component 1702 in a transceiver.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The transmission component 1704 may transmit, to a network node, an indication that a bidirectional full duplex sidelink transmission between the first UE and a second UE is feasible. The transmission component 1704 may transmit, to the network node, sidelink scheduling information that is recommended for the bidirectional full duplex sidelink transmission. The reception component 1702 may receive, from the network node, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible. The transmission component 1704 may transmit, to the second UE, the bidirectional full duplex sidelink transmission based at least in part on the DCI.

The communication manager 1706 may determine that the bidirectional full duplex sidelink transmission is feasible based at least in part on a self-interference measurement, the self-interference measurement being based at least in part on a traffic transmission associated with the first UE or a dedicated reference signal. The transmission component 1704 may transmit, to the second UE, a bidirectional full duplex sidelink feedback based at least in part on candidate combinations of sidelink TCI states. The transmission component 1704 may transmit one or more of the indication that the bidirectional full duplex sidelink transmission between the first UE and the second UE is feasible or the sidelink scheduling information based at least in part on one of: a network node scheduled report, a first UE autonomous report, or an event triggered report.

The transmission component 1704 may transmit, to the first UE, an indication of selected resources associated with a first bidirectional full duplex sidelink transmission. The reception component 1702 may receive, from the second UE, an indication of selected resources associated with a second bidirectional full duplex sidelink transmission. The communication manager 1706 may determine time overlapped resources for the first bidirectional full duplex sidelink transmission based at least in part on the selected resources associated with the first bidirectional full duplex sidelink transmission and the selected resources associated with the second bidirectional full duplex sidelink transmission. The communication manager 1706 may apply full duplex transmit parameters for the time overlapped resources, the full duplex transmit parameters indicating one or more of: a TCI identifier, power information, timing information, ranking information, precoding matrix information, a MIMO scheme, or an mTRP scheme.

The transmission component 1704 may transmit, to the second UE, a request for resources available for a second bidirectional full duplex sidelink transmission associated with the second UE. The reception component 1702 may receive, from the second UE, an indication of the resources available for the second bidirectional full duplex sidelink transmission. The transmission component 1704 may transmit, to the network node, the indication of the resources available for the second bidirectional full duplex sidelink transmission, the DCI that schedules the first bidirectional full duplex sidelink transmission via the sidelink grant indicating time overlapped resources for the first bidirectional full duplex sidelink transmission that corresponds to at least some of the resources available for the second bidirectional full duplex sidelink transmission.

The transmission component 1704 may transmit, to the second UE, an indication of the resources scheduled for the first bidirectional full duplex sidelink transmission as a preferred or non-preferred sidelink resources report.

The reception component 1702 may receive, from the network node, a second DCI associated with the second UE, the second DCI indicating a relayed sidelink grant for the second UE. The transmission component 1704 may transmit, to the second UE and via SCI, the relayed sidelink grant. The reception component 1702 may receive, from the second UE, a second bidirectional full duplex sidelink transmission based at least in part on the relayed sidelink grant.

The number and arrangement of components shown in FIG. 17 are provided as an example. In practice, there may be additional components, fewer components, different components, or differently arranged components than those shown in FIG. 17.

Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication, in accordance with the present disclosure. The apparatus 1800 may be a network node, or a network node may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 150 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 7-14. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the network node described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the network node described in connection with FIG. 2. In some aspects, the reception component 1802 and/or the transmission component 1804 may include or may be included in a network interface. The network interface may be configured to obtain and/or output signals for the apparatus 1800 via one or more communications links, such as a backhaul link, a midhaul link, and/or a fronthaul link.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, a modem, a modulator, a transmit MIMO processor, a transmit processor, a controller/processor, a memory, or a combination thereof, of the network node described in connection with FIG. 2. In some aspects, the transmission component 1804 may be co-located with the reception component 1802 in a transceiver.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

The reception component 1802 may receive, from a first UE, an indication that a bidirectional full duplex sidelink transmission between the first UE and a second UE is feasible. The reception component 1802 may receive, from the first UE, sidelink scheduling information that is recommended for the bidirectional full duplex sidelink transmission. The transmission component 1804 may transmit, to the first UE, DCI that schedules the bidirectional full duplex sidelink transmission via a sidelink grant, the DCI being based at least in part on the sidelink scheduling information and the indication that the bidirectional full duplex sidelink transmission between the first UE and the second UE is feasible.

The transmission component 1804 may transmit, to the second UE, a second DCI that schedules a second bidirectional full duplex sidelink transmission between the second UE and the first UE, and a first bidirectional full duplex sidelink transmission overlapping in a time domain with the second bidirectional full duplex sidelink transmission. The transmission component 1804 may transmit, to the first UE, a second DCI associated with the second UE, the second DCI indicating a relayed sidelink grant for the second UE.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a first user equipment (UE), comprising: transmitting, to a network node, an indication that a bidirectional full duplex sidelink transmission between the first UE and a second UE is feasible; transmitting, to the network node, sidelink scheduling information that is recommended for the bidirectional full duplex sidelink transmission; receiving, from the network node, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible; and transmitting, to the second UE, the bidirectional full duplex sidelink transmission based at least in part on the DCI.

Aspect 2: The method of Aspect 1, further comprising: determining that the bidirectional full duplex sidelink transmission is feasible based at least in part on a self-interference measurement, the self-interference measurement being based at least in part on a traffic transmission associated with the first UE or a dedicated reference signal.

Aspect 3: The method of any of Aspects 1-2, wherein the bidirectional full duplex sidelink transmission is a first bidirectional full duplex sidelink transmission and the DCI is a first DCI, a second DCI scheduling a second bidirectional full duplex sidelink transmission between the second UE and the first UE, and the first bidirectional full duplex sidelink transmission overlapping in a time domain with the second bidirectional full duplex sidelink transmission.

Aspect 4: The method of any of Aspects 1-3, wherein the bidirectional full duplex sidelink transmission is a physical sidelink control channel transmission or a physical sidelink shared channel transmission.

Aspect 5: The method of any of Aspects 1-4, wherein the indication indicates multiple neighbor UEs for which bidirectional full duplex sidelink transmissions are feasible, and each neighbor UE, of the multiple neighbor UEs, being identified by a corresponding UE identifier.

Aspect 6: The method of any of Aspects 1-5, wherein the sidelink scheduling information indicates a sidelink time-frequency resource for the sidelink grant, the sidelink scheduling information indicating relative information between two allocated sidelink resources associated with two sidelink grants for the first UE and the second UE, and the sidelink scheduling information indicating whether the two allocated sidelink resources are non-overlapping in frequency, partially overlapping in frequency, or fully overlapping in frequency.

Aspect 7: The method of any of Aspects 1-6, wherein the sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

Aspect 8: The method of any of Aspects 1-7, wherein the sidelink scheduling information indicates candidate combinations of sidelink transmission configuration indicator (TCI) states of both the first UE and the second UE.

Aspect 9: The method of Aspect 8, wherein the DCI that schedules the bidirectional full duplex sidelink transmission via the sidelink grant is based at least in part on the candidate combinations of sidelink TCI states.

Aspect 10: The method of Aspect 8, further comprising: transmitting, to the second UE, a bidirectional full duplex sidelink feedback based at least in part on the candidate combinations of sidelink TCI states.

Aspect 11: The method of any of Aspects 1-10, wherein the sidelink scheduling information is a partial sidelink scheduling information, remaining sidelink scheduling information being exchanged between the first UE and the second UE via an inter-UE coordination signaling, and the remaining sidelink scheduling information being autonomously applied by the first UE for the bidirectional full duplex sidelink transmission.

Aspect 12: The method of Aspect 11, wherein: the partial sidelink scheduling information indicates a sidelink time-frequency resource for the sidelink grant, the partial sidelink scheduling information indicating relative information between two allocated sidelink resources associated with two sidelink grants for the first UE and the second UE, and the partial sidelink scheduling information indicating whether the two allocated sidelink resources are non-overlapping in frequency, partially overlapping in frequency, or fully overlapping in frequency; and the remaining sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

Aspect 13: The method of Aspect 11, wherein the remaining sidelink scheduling information indicates candidate combinations of sidelink transmission configuration indicator (TCI) states of both the first UE and the second UE, and the bidirectional full duplex sidelink transmission being transmitted based at least in part on the candidate combinations of sidelink TCI states.

Aspect 14: The method of any of Aspects 1-13, wherein the sidelink scheduling information indicates a set of full duplex transmit and receive beams associated with the first UE, the set of full duplex transmit and receive beams indicating at least one transmit beam to at least one neighbor UE and at least one receive beam for at least one neighbor UE, and each transmit beam or receive beam being identified by a reference signal identifier or a transmission configuration indicator identifier.

Aspect 15: The method of Aspect 14, wherein the sidelink scheduling information indicates a preferred multiple transmission reception point scheme or a multiple panel transmit or receive scheme.

Aspect 16: The method of Aspect 14, wherein the sidelink scheduling information indicates other scheduling information per transmit beam or receive beam per neighbor UE, and the other scheduling information indicating one or more of: a time-frequency resource, power information, timing information, ranking information, precoding matrix information, or a multiple-input multiple-output scheme.

Aspect 17: The method of any of Aspects 1-16, wherein transmitting one or more of the indication that the bidirectional full duplex sidelink transmission between the first UE and the second UE is feasible or the sidelink scheduling information is based at least in part on one of: a network node scheduled report, a first UE autonomous report, or an event triggered report.

Aspect 18: The method of any of Aspects 1-17, wherein the bidirectional full duplex sidelink transmission is a first bidirectional full duplex sidelink transmission, and further comprising: transmitting, to the second UE, an indication of selected resources associated with the first bidirectional full duplex sidelink transmission; receiving, from the second UE, an indication of selected resources associated with a second bidirectional full duplex sidelink transmission; determining time overlapped resources for the first bidirectional full duplex sidelink transmission based at least in part on the selected resources associated with the first bidirectional full duplex sidelink transmission and the selected resources associated with the second bidirectional full duplex sidelink transmission; and applying full duplex transmit parameters for the time overlapped resources, the full duplex transmit parameters indicating one or more of: a transmission configuration indicator identifier, power information, timing information, ranking information, precoding matrix information, a multiple-input multiple-output scheme, or a multiple transmission reception point scheme.

Aspect 19: The method of any of Aspects 1-18, wherein the bidirectional full duplex sidelink transmission is a first bidirectional full duplex sidelink transmission, and further comprising: transmitting, to the second UE, a request for resources available for a second bidirectional full duplex sidelink transmission associated with the second UE; receiving, from the second UE, an indication of the resources available for the second bidirectional full duplex sidelink transmission; and transmitting, to the network node, the indication of the resources available for the second bidirectional full duplex sidelink transmission, the DCI that schedules the first bidirectional full duplex sidelink transmission via the sidelink grant indicating time overlapped resources for the first bidirectional full duplex sidelink transmission that corresponds to at least some of the resources available for the second bidirectional full duplex sidelink transmission.

Aspect 20: The method of any of Aspects 1-19, wherein the bidirectional full duplex sidelink transmission is a first bidirectional full duplex sidelink transmission, the DCI that schedules the first bidirectional full duplex sidelink transmission via the sidelink grant indicating resources scheduled for the first bidirectional full duplex sidelink transmission, and further comprising: transmitting, to the second UE, an indication of the resources scheduled for the first bidirectional full duplex sidelink transmission as a preferred or non-preferred sidelink resources report.

Aspect 21: The method of any of Aspects 1-20, wherein the DCI is a first DCI and the bidirectional full duplex sidelink transmission is a first bidirectional full duplex sidelink transmission, and further comprising: receiving, from the network node, a second DCI associated with the second UE, the second DCI indicating a relayed sidelink grant for the second UE; transmitting, to the second UE and via sidelink control information, the relayed sidelink grant; and receiving, from the second UE, a second bidirectional full duplex sidelink transmission based at least in part on the relayed sidelink grant.

Aspect 22: The method of any of Aspects 1-21, wherein the first UE and the second UE are in-coverage UEs, or the first UE is an in-coverage UE and the second UE is an out-of-coverage UE.

Aspect 23: A method of wireless communication performed by a network node, comprising: receiving, from a first user equipment (UE), an indication that a bidirectional full duplex sidelink transmission between the first UE and a second UE is feasible; receiving, from the first UE, sidelink scheduling information that is recommended for the bidirectional full duplex sidelink transmission; and transmitting, to the first UE, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible.

Aspect 24: The method of Aspect 23, wherein the bidirectional full duplex sidelink transmission between the first UE and the second UE is feasible based at least in part on a self-interference measurement.

Aspect 25: The method of any of Aspects 23-24, wherein the bidirectional full duplex sidelink transmission is a first bidirectional full duplex sidelink transmission and the DCI is a first DCI, and further comprising: transmitting, to the second UE, a second DCI that schedules a second bidirectional full duplex sidelink transmission between the second UE and the first UE, and the first bidirectional full duplex sidelink transmission overlapping in a time domain with the second bidirectional full duplex sidelink transmission.

Aspect 26: The method of any of Aspects 23-25, wherein the bidirectional full duplex sidelink transmission is a physical sidelink control channel transmission or a physical sidelink shared channel transmission.

Aspect 27: The method of any of Aspects 23-26, wherein the indication indicates multiple neighbor UEs for which bidirectional full duplex sidelink transmissions are feasible, and each neighbor UE, of the multiple neighbor UEs, being identified by a corresponding UE identifier.

Aspect 28: The method of any of Aspects 23-27, wherein the sidelink scheduling information indicates a sidelink time-frequency resource for the sidelink grant, the sidelink scheduling information indicating relative information between two allocated sidelink resources associated with two sidelink grants for the first UE and the second UE, and the sidelink scheduling information indicating whether the two allocated sidelink resources are non-overlapping in frequency, partially overlapping in frequency, or fully overlapping in frequency.

Aspect 29: The method of any of Aspects 23-28, wherein the sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

Aspect 30: The method of any of Aspects 23-29, wherein the sidelink scheduling information indicates candidate combinations of sidelink transmission configuration indicator states of both the first UE and the second UE.

Aspect 31: The method of any of Aspects 23-30, wherein the sidelink scheduling information is a partial sidelink scheduling information, remaining sidelink scheduling information being exchanged between the first UE and the second UE via an inter-UE coordination signaling, and the remaining sidelink scheduling information being autonomously applied by the first UE for the bidirectional full duplex sidelink transmission.

Aspect 32: The method of Aspect 31, wherein: the partial sidelink scheduling information indicates a sidelink time-frequency resource for the sidelink grant, the partial sidelink scheduling information indicating relative information between two allocated sidelink resources associated with two sidelink grants for the first UE and the second UE, and the partial sidelink scheduling information indicating whether the two allocated sidelink resources are non-overlapping in frequency, partially overlapping in frequency, or fully overlapping in frequency; and the remaining sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

Aspect 33: The method of Aspect 31, wherein the remaining sidelink scheduling information indicates candidate combinations of sidelink transmission configuration indicator states of both the first UE and the second UE, and the bidirectional full duplex sidelink transmission being transmitted based at least in part on the candidate combinations of sidelink TCI states.

Aspect 34: The method of any of Aspects 23-33, wherein the sidelink scheduling information indicates a set of full duplex transmit and receive beams associated with the first UE, the set of full duplex transmit and receive beams indicating at least one transmit beam to at least one neighbor UE and at least one receive beam for at least one neighbor UE, and each transmit beam or receive beam being identified by a reference signal identifier or a transmission configuration indicator identifier.

Aspect 35: The method of Aspect 34, wherein the sidelink scheduling information indicates a preferred multiple transmission reception point scheme or a multiple panel transmit or receive scheme.

Aspect 36: The method of Aspect 34, wherein the sidelink scheduling information indicates other scheduling information per transmit beam or receive beam per neighbor UE, and the other scheduling information indicating one or more of: a time-frequency resource, power information, timing information, ranking information, precoding matrix information, or a multiple-input multiple-output scheme.

Aspect 37: The method of any of Aspects 23-36, wherein the DCI is a first DCI, and further comprising: transmitting, to the first UE, a second DCI associated with the second UE, the second DCI indicating a relayed sidelink grant for the second UE.

Aspect 38: The method of any of Aspects 23-37, wherein the first UE and the second UE are in-coverage UEs, or the first UE is an in-coverage UE and the second UE is an out-of-coverage UE.

Aspect 39: An apparatus for wireless communication at a device, comprising a processor; memory coupled with the processor; and instructions stored in the memory and executable by the processor to cause the apparatus to perform the method of one or more of Aspects 1-22.

Aspect 40: A device for wireless communication, comprising a memory and one or more processors coupled to the memory, the one or more processors configured to perform the method of one or more of Aspects 1-22.

Aspect 41: An apparatus for wireless communication, comprising at least one means for performing the method of one or more of Aspects 1-22.

Aspect 42: A non-transitory computer-readable medium storing code for wireless communication, the code comprising instructions executable by a processor to perform the method of one or more of Aspects 1-22.

Aspect 43: A non-transitory computer-readable medium storing a set of instructions for wireless communication, the set of instructions comprising one or more instructions that, when executed by one or more processors of a device, cause the device to perform the method of one or more of Aspects 1-22.

Aspect 44: An apparatus for wireless communication at a device, comprising a processor; memory coupled with the processor; and instructions stored in the memory and executable by the processor to cause the apparatus to perform the method of one or more of Aspects 23-38.

Aspect 45: A device for wireless communication, comprising a memory and one or more processors coupled to the memory, the one or more processors configured to perform the method of one or more of Aspects 23-38.

Aspect 46: An apparatus for wireless communication, comprising at least one means for performing the method of one or more of Aspects 23-38.

Aspect 47: A non-transitory computer-readable medium storing code for wireless communication, the code comprising instructions executable by a processor to perform the method of one or more of Aspects 23-38.

Aspect 48: A non-transitory computer-readable medium storing a set of instructions for wireless communication, the set of instructions comprising one or more instructions that, when executed by one or more processors of a device, cause the device to perform the method of one or more of Aspects 23-38.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,”“have,”“having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors coupled with the memory and configured to cause the first UE to:
transmit, to a network node, an indication that a bidirectional full duplex sidelink transmission between the first UE and a second UE is feasible;
transmit, to the network node, sidelink scheduling information that is recommended for the bidirectional full duplex sidelink transmission;
receive, from the network node, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible; and
transmit, to the second UE, the bidirectional full duplex sidelink transmission based at least in part on the DCI.

2. The first UE of claim 1, wherein the one or more processors are further configured to cause the first UE to:
determine that the bidirectional full duplex sidelink transmission is feasible based at least in part on a self-interference measurement, the self-interference measurement being based at least in part on a traffic transmission associated with the first UE or a dedicated reference signal.

3. The first UE of claim 1, wherein the bidirectional full duplex sidelink transmission is a first bidirectional full duplex sidelink transmission and the DCI is a first DCI, a second DCI scheduling a second bidirectional full duplex sidelink transmission between the second UE and the first UE, and the first bidirectional full duplex sidelink transmission overlapping in a time domain with the second bidirectional full duplex sidelink transmission.

4. The first UE of claim 1, wherein the bidirectional full duplex sidelink transmission is a physical sidelink control channel transmission or a physical sidelink shared channel transmission.

5. The first UE of claim 1, wherein the indication indicates multiple neighbor UEs for which bidirectional full duplex sidelink transmissions are feasible, and each neighbor UE, of the multiple neighbor UEs, being identified by a corresponding UE identifier.

6. The first UE of claim 1, wherein the sidelink scheduling information indicates a sidelink time-frequency resource for the sidelink grant, the sidelink scheduling information indicating relative information between two allocated sidelink resources associated with two sidelink grants for the first UE and the second UE, and the sidelink scheduling information indicating whether the two allocated sidelink resources are non-overlapping in frequency, partially overlapping in frequency, or fully overlapping in frequency.

7. The first UE of claim 1, wherein the sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

8. The first UE of claim 1, wherein the sidelink scheduling information indicates candidate combinations of sidelink transmission configuration indicator (TCI) states of both the first UE and the second UE.

9. The first UE of claim 8, wherein the DCI that schedules the bidirectional full duplex sidelink transmission via the sidelink grant is based at least in part on the candidate combinations of sidelink TCI states.

10. The first UE of claim 8, wherein the one or more processors are further configured to cause the first UE to:
transmit, to the second UE, a bidirectional full duplex sidelink feedback based at least in part on the candidate combinations of sidelink TCI states.

11. The first UE of claim 1, wherein the sidelink scheduling information is a partial sidelink scheduling information, remaining sidelink scheduling information being exchanged between the first UE and the second UE via an inter-UE coordination signaling, and the remaining sidelink scheduling information being autonomously applied by the first UE for the bidirectional full duplex sidelink transmission.

12. The first UE of claim 11, wherein:
the partial sidelink scheduling information indicates a sidelink time-frequency resource for the sidelink grant, the partial sidelink scheduling information indicating relative information between two allocated sidelink resources associated with two sidelink grants for the first UE and the second UE, and the partial sidelink scheduling information indicating whether the two allocated sidelink resources are non-overlapping in frequency, partially overlapping in frequency, or fully overlapping in frequency; and
the remaining sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

13. The first UE of claim 11, wherein the remaining sidelink scheduling information indicates candidate combinations of sidelink transmission configuration indicator (TCI) states of both the first UE and the second UE, and the bidirectional full duplex sidelink transmission being transmitted based at least in part on the candidate combinations of sidelink TCI states.

14. The first UE of claim 1, wherein the sidelink scheduling information indicates a set of full duplex transmit and receive beams associated with the first UE, the set of full duplex transmit and receive beams indicating at least one transmit beam to at least one neighbor UE and at least one receive beam for at least one neighbor UE, and each transmit beam or receive beam being identified by a reference signal identifier or a transmission configuration indicator identifier.

15. The first UE of claim 14, wherein the sidelink scheduling information indicates a preferred multiple transmission reception point scheme or a multiple panel transmit or receive scheme.

16. The first UE of claim 14, wherein the sidelink scheduling information indicates other scheduling information per transmit beam or receive beam per neighbor UE, and the other scheduling information indicating one or more of: a time-frequency resource, power information, timing information, ranking information, precoding matrix information, or a multiple-input multiple-output scheme.

17. The first UE of claim 1, wherein the one or more processors are configured to transmit one or more of the indication that the bidirectional full duplex sidelink transmission between the first UE and the second UE is feasible or the sidelink scheduling information based at least in part on one of: a network node scheduled report, a first UE autonomous report, or an event triggered report.

18. The first UE of claim 1, wherein the bidirectional full duplex sidelink transmission is a first bidirectional full duplex sidelink transmission, and the one or more processors are further configured to cause the first UE to:
transmit, to the second UE, an indication of selected resources associated with the first bidirectional full duplex sidelink transmission;
receive, from the second UE, an indication of selected resources associated with a second bidirectional full duplex sidelink transmission;
determine time overlapped resources for the first bidirectional full duplex sidelink transmission based at least in part on the selected resources associated with the first bidirectional full duplex sidelink transmission and the selected resources associated with the second bidirectional full duplex sidelink transmission; and
apply full duplex transmit parameters for the time overlapped resources, the full duplex transmit parameters indicating one or more of: a transmission configuration indicator identifier, power information, timing information, ranking information, precoding matrix information, a multiple-input multiple-output scheme, or a multiple transmission reception point scheme.

19. The first UE of claim 1, wherein the bidirectional full duplex sidelink transmission is a first bidirectional full duplex sidelink transmission, and the one or more processors are further configured to cause the first UE to:
transmit, to the second UE, a request for resources available for a second bidirectional full duplex sidelink transmission associated with the second UE;
receive, from the second UE, an indication of the resources available for the second bidirectional full duplex sidelink transmission; and
transmit, to the network node, the indication of the resources available for the second bidirectional full duplex sidelink transmission, the DCI that schedules the first bidirectional full duplex sidelink transmission via the sidelink grant indicating time overlapped resources for the first bidirectional full duplex sidelink transmission that corresponds to at least some of the resources available for the second bidirectional full duplex sidelink transmission.

20. The first UE of claim 1, wherein the bidirectional full duplex sidelink transmission is a first bidirectional full duplex sidelink transmission, the DCI that schedules the first bidirectional full duplex sidelink transmission via the sidelink grant indicating resources scheduled for the first bidirectional full duplex sidelink transmission, and the one or more processors are further configured to cause the first UE to:
transmit, to the second UE, an indication of the resources scheduled for the first bidirectional full duplex sidelink transmission as a preferred or non-preferred sidelink resources report.

21. The first UE of claim 1, wherein the DCI is a first DCI and the bidirectional full duplex sidelink transmission is a first bidirectional full duplex sidelink transmission, and the one or more processors are further configured to cause the first UE to:
receive, from the network node, a second DCI associated with the second UE, the second DCI indicating a relayed sidelink grant for the second UE;
transmit, to the second UE and via sidelink control information, the relayed sidelink grant; and
receive, from the second UE, a second bidirectional full duplex sidelink transmission based at least in part on the relayed sidelink grant.

22. The first UE of claim 1, wherein the first UE and the second UE are in-coverage UEs, or the first UE is an in-coverage UE and the second UE is an out-of-coverage UE.

23. A network node for wireless communication, comprising:
a memory; and
one or more processors coupled with the memory and configured to cause the network node to:
receive, from a first user equipment (UE), an indication that a bidirectional full duplex sidelink transmission between the first UE and a second UE is feasible;
receive, from the first UE, sidelink scheduling information that is recommended for the bidirectional full duplex sidelink transmission; and
transmit, to the first UE, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible.

24. The network node of claim 23, wherein the bidirectional full duplex sidelink transmission is a first bidirectional full duplex sidelink transmission and the DCI is a first DCI, and the one or more processors are further configured to cause the network node to:
transmit, to the second UE, a second DCI that schedules a second bidirectional full duplex sidelink transmission between the second UE and the first UE, and the first bidirectional full duplex sidelink transmission overlapping in a time domain with the second bidirectional full duplex sidelink transmission.

25. The network node of claim 23, wherein:
the sidelink scheduling information indicates a sidelink time-frequency resource for the sidelink grant, the sidelink scheduling information indicating relative information between two allocated sidelink resources associated with two sidelink grants for the first UE and the second UE, and the sidelink scheduling information indicating whether the two allocated sidelink resources are non-overlapping in frequency, partially overlapping in frequency, or fully overlapping in frequency; or
the sidelink scheduling information indicates non-time-frequency allocation information for a sidelink resource associated with the sidelink grant, and the non-time-frequency allocation information indicating one or more of: a sidelink transmit beam, a transmission configuration indicator identifier, power information, timing information, ranking information, precoding matrix information, a multiple-input multiple-output scheme, or a multiple transmission reception point scheme.

26. The network node of claim 23, wherein the sidelink scheduling information is a partial sidelink scheduling information, remaining sidelink scheduling information being exchanged between the first UE and the second UE via an inter-UE coordination signaling, and the remaining sidelink scheduling information being autonomously applied by the first UE for the bidirectional full duplex sidelink transmission.

27. The network node of claim 23, wherein the sidelink scheduling information indicates a set of full duplex transmit and receive beams associated with the first UE, the set of full duplex transmit and receive beams indicating at least one transmit beam to at least one neighbor UE and at least one receive beam for at least one neighbor UE, and each transmit beam or receive beam being identified by a reference signal identifier or a transmission configuration indicator identifier.

28. The network node of claim 23, wherein the DCI is a first DCI, and the one or more processors are further configured to cause the network node to:
transmit, to the first UE, a second DCI associated with the second UE, the second DCI indicating a relayed sidelink grant for the second UE.

29. A method of wireless communication performed by a first user equipment (UE), comprising:
transmitting, to a network node, an indication that a bidirectional full duplex sidelink transmission between the first UE and a second UE is feasible;
transmitting, to the network node, sidelink scheduling information that is recommended for the bidirectional full duplex sidelink transmission;
receiving, from the network node, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible; and
transmitting, to the second UE, the bidirectional full duplex sidelink transmission based at least in part on the DCI.

30. A method of wireless communication performed by a network node, comprising:
receiving, from a first user equipment (UE), an indication that a bidirectional full duplex sidelink transmission between the first UE and a second UE is feasible;
receiving, from the first UE, sidelink scheduling information that is recommended for the bidirectional full duplex sidelink transmission; and
transmitting, to the first UE, downlink control information (DCI) that schedules the bidirectional full duplex sidelink transmission via a sidelink grant, the DCI being based at least in part on the sidelink scheduling information and the indication that the bidirectional full duplex sidelink transmission between the first UE and the second UE is feasible.
